(19) United States
(12) Patent Application Publication
(10) Pub. No.: US 2024/0187870 A1
(43) Pub. Date: Jun. 6, 2024

(54) SIDE LINK (SL) USER EQUIPMENT (UE) CELL SELECTION AT OUT-OF-COVERAGE AND IN-COVERAGE TRANSITION

(71) Applicant: Telefonaktiebolaget LM Ericsson (PUBL), Stockholm (SE)

(72) Inventors: Chunhui Zhang, STOCKHOLM (SE); Muhammad Kazmi, SUNDBYBERG (SE); Santhan Thangarasa, VÄLLINGBY (SE); Christian Bergljung, LUND (SE); Min Wang, LULEÅ (SE)

(21) Appl. No.: 18/551,522

(22) PCT Filed: Mar. 22, 2022
(86) PCT No.: PCT/SE2022/050269

§ 371 Date: Sep. 20, 2023

Related U.S. Application Data
(60) Provisional application No. 63/164,686, filed on Mar. 23, 2021.

(51) Int. Cl. H04W 16/18; H04W 52/36; H04W 92/18

(52) U.S. Cl. CPC H04W 16/18; H04W 52/367; H04W 92/18

(57) ABSTRACT

According to certain embodiments, a method performed by a wireless device comprises obtaining one or more parameters to determine coverage detection criteria. The coverage detection criteria indicates whether sidelink operation of the wireless device is considered to be inside or outside coverage of a cell. The method further comprises determining, based on the one or more parameters, whether the sidelink operation of the wireless device is considered to be inside or outside the coverage of the cell and adjusting the sidelink operation based on whether the sidelink operation of the wireless device is considered to be inside or outside the coverage of the cell.

### TECHNICAL FIELD

Certain embodiments of the present disclosure relate, in general, to side link (SL) user equipment (UE) cell selection at out-of-coverage and in-coverage transition.

### BACKGROUND

The Third Generation Partnership Project (3GPP) New Radio (NR) sidelink enhancement Work Item Description (WID) (RP-201516) includes an objective to study the co-existing mechanism between sidelink (SL) and the cellular interface (named Uu): support of new sidelink frequency bands should ensure coexistence between sidelink and Uu interface in the same and adjacent channels in licensed spectrum.

### Sidelink Operation

FIG. 1 illustrates an example of a network that supports SL operation. SL operation comprises direct communication of signals between at least two user equipment (UEs). SL operation may also be referred to as SL communication, device-to-device (D2D) operation, or peer-to-peer operation. SL operation can be used for commercial or public safety applications. The D2D operation is a generic term which may comprise transmission and/or reception of any type of D2D signals (e.g., physical signals, physical channel, etc.) by a D2D communication capable UE and/or by D2D discovery capable UE. Thus, D2D operation may also be referred to as D2D transmission, D2D reception, D2D communication, proximity services (ProSe), vehicle-to-X (V2X), etc.

V2X communication includes any combination of direct communication between vehicles, pedestrians and infrastructure. Therefore, X may denote ‘vehicular’ (vehicle-to-vehicle or “V2V”) or X may denote ‘pedestrian’ (vehicle-to-pedestrian or “V2P”) or X may denote ‘infrastructure’ (vehicle-to-infrastructure or “V2I”) and so on. The embodiments described herein apply to any type of D2D operation including ProSe, V2X, and so on.

V2X communication takes place on radio resources on SL. The SL can be configured on a dedicated carrier (e.g., in a carrier of the Intelligent Transport System (ITS) band) or a carrier of the serving cell of the UE. In the latter case, the SL resources and resources for cellular communication (over Uu link) are shared in time and/or frequency. Typically, the SL resources are time multiplexed with the uplink resources used for cellular communication on the serving cell of the UE.

Broadcast, groupcast, and unicast transmissions for V2X operation on the SL are supported for the in-coverage, out-of-coverage and partial-coverage scenarios. For unicast and groupcast transmissions on SL, Hybrid Automatic Repeat Request (HARQ) feedback and HARQ combining in the physical layer of the UE are supported.

For the in-coverage UE, a gNB (a base station in NR) can be configured to adopt Mode 1 or Mode 2. For the out-of-coverage UE, only Mode 2 can be adopted.

As in Long Term Evolution (LTE), scheduling over the sidelink in NR is done in different ways for Mode 1 and Mode 2. Mode 1 supports the two kinds of grants: dynamic grant and configured grant.

Dynamic grant: When the traffic to be sent over sidelink arrives at a transmitter UE, this UE should launch the four-message exchange procedure to request sidelink resources from a gNB (Scheduling Request (SR) on uplink (UL), grant, Buffer Status Report (BSR) on UL, grant for data on SL sent to UE). During the resource request procedure, a gNB (e.g., a base station in NR) may allocate a sidelink radio network temporary identifier (SL-RNTI) to the transmitter UE. If this sidelink resource request is granted by a gNB, then a gNB indicates the resource allocation for the Physical Sidelink Control Channel (PSCCH) and the Physical Sidelink Shared Channel (PSSCH) in the downlink control information (DCI) conveyed by Physical Downlink Control Channel (PDCCH) with cyclic redundancy check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH. The transmitter UE launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the sidelink control information (SCI).

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ acknowledgement (ACK)/negative-acknowledgement (NACK) transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:

1) The PSSCH associated with the PSCCH for initial transmission and blind retransmissions.

2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring Reference Signal Received Power (RSRP) on different subchannels and requires knowledge of the different UEs power levels of demodulation reference signal (DMRS) on the PSSCH or the DMRS on the PSCCH depending on the configuration. This information is known only after receiver SCI is launched by (all) other UEs. The sensing and selection algorithm is rather complex.

### In-Coverage Evaluation Criterion

In 3GPP Technical Specification (TS) 38.304 v16.3.0, the cell selection/reselection is defined for SL UE to evaluate the in-coverage or out-of-coverage criterion as follows:

When UE is interested to perform NR sidelink communication on non-serving frequency, it may perform measurements on that frequency or the frequencies that can provide inter carrier NR sidelink configuration for that frequency for cell selection and reselection purpose in accordance with TS 38.133 v16.6.0. When UE is interested to perform V2X sidelink communication on non-serving frequency, it may perform measurements on that frequency or the frequencies which can provide inter carrier V2X sidelink configuration for that frequency for cell selection and intra-frequency reselection purpose in accordance with TS 38.133 v16.6.0.

If the UE detects at least one cell on the frequency that the UE is configured to perform NR sidelink communication on fulfilling the S criterion in accordance with clause 8.2.1 (TS 38.304 v16.3.0), it shall consider itself to be in-coverage (“IC”) for NR sidelink communication on that frequency. If the UE cannot detect any cell on that frequency meeting the S criterion, it shall consider itself to be out-of-coverage (“OOC”) for NR sidelink communication on that frequency.

If the UE detects at least one cell on the frequency which UE is configured to perform V2X sidelink communication on fulfilling the S criterion in accordance with clause 8.2.1 (TS 38.304 v16.3.0), it shall consider itself to be in-coverage for V2X sidelink communication on that frequency. If the UE cannot detect any cell on that frequency meeting the S criterion, it shall consider itself to be out-of-coverage for V2X sidelink communication on that frequency.

### SUMMARY

There currently exist certain challenge(s). For example, the SL enhancement WID of 3GPP Release 17 (Rel-17) introduces an SL operation in which SL UE can operate in the licensed band. In one scenario, SL operation could be only allowed in out-of-coverage of network. This may be due to limited frequency spectrum. As an example, band n14 comprises only 2*10 MHz frequency range: uplink (UL) 788-798 MHz and downlink (DL) 758-768 MHz. A dedicated channel for SL operation would reduce the network spectrum usage and it would be difficult for Band n14, which is the public safety band in some regions.

In legacy sidelink operation, the power class of the SL UE is the same as that of a cellular UE. For example, both SL and Uu UEs belong to power class 3 when operating on licensed band, such as in band n38 (2570 MHz-2620 MHz). Power class 2 (PC2) SL UE will be introduced in NR licensed band n38 in Rel-17. The network will configure the maximum allowed UE transmit power with the information element (IE) p-max for NR Uu UE. In the case where SL UE power class is higher than Uu UE maximum allowed transmission power in the cell, the SL UE transmission power will be different with the allowed NR/LTE Uu UE output power. Thus, to have a better co-channel coexisting of SL UE and NR/LTE UE in the same geographic region, there is a need to specify the UE behavior when SL UE operation moves from out-of-coverage to in-coverage and vice versa, so the co-channel interference could be minimized. Note that the terms transmit power and transmission power may be used interchangeably.

Certain aspects of the present disclosure and their embodiments may provide solutions to these or other challenges. For example, certain embodiments provide solutions for maintaining good performance of both NR network and Sidelink coverage. The SL UE at higher output power than the maximum allowed power in the network can detect the in-coverage (wireless access network (WAN) cell) early and can take one or more actions in response. Examples of actions may include stopping SL operation, continuing SL operation with reduced maximum transmit power, etc.

There are, proposed herein, various embodiments which address one or more of the issues disclosed herein.

In a first embodiment, a SL UE operating in out-of-coverage determines one or more parameters (e.g., Pcompensation) for evaluating cell selection criteria for a cell (e.g., in same carrier where SL is operating) and uses the determined parameter(s) for evaluating the cell selection criteria. In one example, if the UE determines that it meets the cell selection criteria for that cell, then the UE stops the SL operation (e.g., stop transmission of SL signals, stop transmission and reception of SL signals, etc.). In another example, if the UE determines that it meets the cell selection criteria for that cell, then the UE reduces its maximum transmit power for SL transmission by certain margin (e.g., DP) and continues the SL operation with reduced maximum SL transmission power. In the latter case, the UE may further determine whether it meets the cell selection criteria for a cell at later time, such as periodically once every T1 time resource (e.g., every 2 second, every L1 frames, every L2 discontinuous reception (DRX) cycles, etc.) and decide whether or not to continue SL operation or can further continue the SL operation by further reducing its maximum SL power.

In a second embodiment, the SL UE (e.g., UE2) receives from another UE (e.g., UE1) assistance information related to the SL operation in one or more cells, and uses the assistance information (e.g., maximum configured power for SL in the cell, etc.) for adapting one or more procedures related to cell reselection, for example, evaluation of the cell selection criteria for one or more cells. In one example, UE1 is in the in-coverage of at least one cell and therefore UE2 is in partial coverage with respect to the cell. In another example, UE1 has been recently in the in-coverage of at least one cell (e.g., until time instance T2 from the moment UE1 sends/broadcasts the assistance information). In this case UE2 is in OOC with respect to the cell.

In another embodiment, the SL UE is being served by a serving cell (e.g., cell1). The serving cell sends cell change command (e.g., handover (HO) command) for the SL UE to a target cell (e.g., cell2) containing information about the SL UE power class for the SL operation. The target cell determines or assesses a relation between the SL UE power class and the UE power level (e.g., SL power class, maximum allowed UE Tx power, configured maximum UE Tx power in the target cell, etc.) and uses the results of the assessment for one or more operations. In one example, the target cell rejects the HO if the SL UE's power class is not the same as the SL power class supported in the target cell; otherwise the HO to the target cell is allowed. In another example, the target cell rejects the HO if the SL UE's power class is not larger than the SL power class supported in the target cell; otherwise the HO to the target cell is allowed.

According to certain embodiments, a method performed by a wireless device comprises obtaining one or more parameters to determine coverage detection criteria. The coverage detection criteria indicates whether sidelink operation of the wireless device is considered to be inside or outside coverage of a cell. The method further comprises determining, based on the one or more parameters, whether the sidelink operation of the wireless device is considered to be inside or outside the coverage of the cell and adjusting the sidelink operation based on whether the sidelink operation of the wireless device is considered to be inside or outside the coverage of the cell.

According to certain embodiments, a wireless device comprises power supply circuitry configured to supply power to the wireless device and processing circuitry configured to obtain one or more parameters to determine coverage detection criteria. The coverage detection criteria indicates whether sidelink operation of the wireless device is considered to be inside or outside coverage of a cell. The processing circuitry is further configured to determine, based on the one or more parameters, whether the sidelink operation of the wireless device is considered to be inside or outside the coverage of the cell. The processing circuitry is further configured to adjust the sidelink operation based on whether the sidelink operation of the wireless device is considered to be inside or outside the coverage of the cell.

According to certain embodiments, a computer program comprises instructions which when executed on a computer perform steps comprising obtaining one or more parameters to determine coverage detection criteria. The coverage detection criteria indicates whether sidelink operation of the wireless device is considered to be inside or outside coverage of a cell. The steps further comprise determining, based on the one or more parameters, whether the sidelink operation of the wireless device is considered to be inside or outside the coverage of the cell and adjusting the sidelink operation based on whether the sidelink operation of the wireless device is considered to be inside or outside the coverage of the cell.

A computer program product comprising a computer program, the computer program comprising instructions which when executed on a computer perform steps comprising obtaining one or more parameters to determine coverage detection criteria. The coverage detection criteria indicates whether sidelink operation of the wireless device is considered to be inside or outside coverage of a cell. The steps further comprise determining, based on the one or more parameters, whether the sidelink operation of the wireless device is considered to be inside or outside the coverage of the cell and adjusting the sidelink operation based on whether the sidelink operation of the wireless device is considered to be inside or outside the coverage of the cell.

A non-transitory computer-readable storage medium or carrier comprising a computer program, the computer program comprising instructions which when executed on a computer perform steps comprising obtaining one or more parameters to determine coverage detection criteria. The coverage detection criteria indicates whether sidelink operation of the wireless device is considered to be inside or outside coverage of a cell. The steps further comprise determining, based on the one or more parameters, whether the sidelink operation of the wireless device is considered to be inside or outside the coverage of the cell and adjusting the sidelink operation based on whether the sidelink operation of the wireless device is considered to be inside or outside the coverage of the cell.

The method performed by a wireless device, the wireless device, the computer program, the computer program product, and/or the non-transitory computer-readable storage medium described above may include any other suitable features, such as any one or more of the following features:

In certain embodiments, determining, based on the one or more parameters, whether the sidelink operation of the wireless device is considered to be inside or outside the coverage of the cell comprises determining a power compensation (Pcompensation) value based on the one or more parameters and determining whether the sidelink operation of the wireless device is considered to be inside or outside the coverage of the cell based on the Pcompensation value. In certain embodiments, the one or more parameters for determining the Pcompensation value comprise one or more of the following: maximum transmit power of the wireless device in a cell (P_{EMAX}), maximum transmit power of the wireless device in the sidelink (P_{MAX, SL}), and/or a power class of the wireless device in sidelink (P_{PowerClass, SL}). In certain embodiments, the Pcompensation value is used to determine a signal strength threshold and determining whether the sidelink operation of the wireless device is considered to be inside or outside the coverage of the cell is based on the signal strength threshold. For example, certain embodiments evaluate whether the wireless device meets a cell selection criterion for the cell based on at least the signal strength threshold, and determining whether the sidelink operation of the wireless device is considered to be inside or outside the coverage of the cell is based on whether the wireless device meets the cell selection criterion for the cell.

In certain embodiments, adjusting the sidelink operation comprises one or more of the following: stopping transmission of sidelink signals, stopping reception of sidelink signals, reducing a maximum transmit power used for transmission of sidelink signals, or switching a mode used by the wireless device. For example, certain embodiments switch a mode that affects whether resource allocation is controlled by a network node or autonomously by the wireless device. Certain embodiments switch from Mode 1 to Mode 2 (or from Mode 2 to Mode 1).

In certain embodiments, determining whether the sidelink operation of the wireless device is considered to be inside or outside the coverage of the cell is performed when the wireless device is configured to use an out-of-coverage configuration for the sidelink operation.

In certain embodiments, determining whether the sidelink operation of the wireless device is considered to be inside or outside the coverage of the cell is performed when the wireless device is configured to use an in-coverage configuration for the sidelink operation.

Certain embodiments perform one or more of the following in response to determining that the wireless device is no longer considered to be inside the coverage of any cell: enabling transmission of sidelink signals, enabling reception of sidelink signals, and/or increasing a maximum transmit power used for transmission of the sidelink signals.

Certain embodiments perform the determining of whether the sidelink operation of the wireless device is considered to be inside or outside the coverage of the cell with respect to one or more carriers prone to interference from the sidelink operation. Certain embodiments determine the one or more carriers that are prone to interference from the sidelink operation based on pre-defined criteria. The pre-defined criteria indicates that one or more of the following carriers are prone to interference from the sidelink operation: a carrier that is the same as a carrier that the wireless device uses for sidelink operation, a carrier that is adjacent to the carrier that the wireless device uses for sidelink operation, a carrier that is in a same band as the carrier that the wireless device uses for sidelink operation, and/or a carrier that is within a pre-determined frequency of the carrier that the wireless device uses for sidelink operation.

In certain embodiments, at least one of the one or more parameters to determine the coverage detection criteria is based on at least one of the following values: reference signal received power (RSRP), reference signal received quality (RSRQ), received signal strength indicator (RSSI), signal-to-interference ratio (SIR), signal-to-interference plus noise ratio (SINR), maximum transmit power of the wireless device in a cell (P_{EMAX}), maximum transmit power of the wireless device in the sidelink (P_{MAX, SL}), and/or power class of the wireless device in sidelink (P_{PowerClass, SL}).

In certain embodiments, at least one of the one or more parameters is obtained from a second wireless device via the sidelink operation. In an embodiment, the second wireless device is in-coverage of a network comprising the cell. In another embodiment, the second wireless device is out-of-coverage of a network comprising the cell but was previously in-coverage of the network within a pre-determined period.

According to certain embodiments, a method performed by a network node, comprises transmitting, to a wireless device, one or more parameters that the wireless device uses to determine coverage detection criteria. The coverage detection criteria indicates whether sidelink operation of the wireless device is considered to be inside or outside coverage of a cell.

According to certain embodiments, a network node comprises power supply circuitry configured to supply power to the network node and processing circuitry configured transmit, to a wireless device, one or more parameters that the wireless device uses to determine coverage detection criteria. The coverage detection criteria indicates whether sidelink operation of the wireless device is considered to be inside or outside coverage of a cell.

According to certain embodiments, a computer program comprises instructions which when executed on a computer perform steps comprising transmitting, to a wireless device, one or more parameters that the wireless device uses to determine coverage detection criteria. The coverage detection criteria indicates whether sidelink operation of the wireless device is considered to be inside or outside coverage of a cell.

According to certain embodiments, a computer program product comprises a computer program, the computer program comprising instructions which when executed on a computer perform steps comprising transmitting, to a wireless device, one or more parameters that the wireless device uses to determine coverage detection criteria. The coverage detection criteria indicates whether sidelink operation of the wireless device is considered to be inside or outside coverage of a cell.

According to certain embodiments, a non-transitory computer-readable storage medium or carrier comprises a computer program, the computer program comprising instructions which when executed on a computer perform steps comprising transmitting, to a wireless device, one or more parameters that the wireless device uses to determine coverage detection criteria. The coverage detection criteria indicates whether sidelink operation of the wireless device is considered to be inside or outside coverage of a cell.

The method performed by a network node, the network node, the computer program, the computer program product, and/or the non-transitory computer-readable storage medium described above may include any other suitable features, such as any one or more of the following features:

Certain embodiments determine the one or more parameters to transmit to the wireless device.

In certain embodiments, the one or more parameters comprise one or more of the following: a maximum transmit power of the wireless device in a cell (P_{EMAX}), a maximum transmit power of the wireless device in the sidelink (P_{MAX, SL}), and/or a power class of the wireless device in sidelink (P_{PowerClass, SL}).

In certain embodiments, the one or more parameters comprise a compensation parameter for adjusting a parameter for evaluating cell selection criterion that the wireless device is configured to use to determine whether sidelink operation of the wireless device is considered to be inside or outside coverage of a cell.

In certain embodiments, the one or more parameters comprise one or more of: a first maximum allowed sidelink transmission power associated with Mode 2 and an out-of-coverage condition, a second maximum allowed sidelink transmission power associated with the Mode 2 and an in-coverage condition, and/or a third maximum allowed sidelink transmission power associated with Mode 1 and the in-coverage condition.

In certain embodiments, at least one of the one or more parameters is transmitted in System Information.

In certain embodiments, at least one of the one or more parameters is transmitted in dedicated radio resource control (RRC) signaling.

In certain embodiments, at least one of the one or more parameters is transmitted in a Medium Access Control-Control Element (MAC CE).

In certain embodiments, at least one of the one or more parameters is transmitted in layer 1 (L1) signaling. In certain embodiments, the L1 signaling is on a Physical Downlink Control Channel (PDCCH) or a Physical Downlink Shared Channel (PDSCH).

In certain embodiments, the one or more parameters indicate that the wireless device is to stop transmission of sidelink signals when the wireless device is considered to be inside coverage of the cell.

In certain embodiments, the one or more parameters indicate that the wireless device is to stop reception of sidelink signals when the wireless device is considered to be inside coverage of the cell.

In certain embodiments, the one or more parameters indicate that the wireless device is to reduce a maximum transmit power used for transmission of sidelink signals when the wireless device is considered to be inside coverage of the cell.

In certain embodiments, the one or more parameters indicate that the wireless device is to periodically determine whether the sidelink operation of the wireless device is considered to be inside or outside the coverage of the cell.

In certain embodiments, at least one of the one or more parameters indicates that the wireless device is to determine whether the sidelink operation of the wireless device is considered to be inside or outside the coverage of the cell with respect to at least one of the following carriers: a carrier that is the same as a carrier that the wireless device uses for sidelink operation, a carrier that is adjacent to the carrier that the wireless device uses for sidelink operation, a carrier that is in a same band as the carrier that the wireless device uses for sidelink operation, and/or a carrier that is within a pre-determined frequency of the carrier that the wireless device uses for sidelink operation.

In certain embodiments, at least one of the one or more parameters to determine coverage detection criteria is based on at least one of the following values: reference signal received power (RSRP), reference signal received quality (RSRQ), received signal strength indicator (RSSI), signal-to-interference ratio (SIR), signal-to-interference plus noise ratio (SINR), maximum transmit power of the wireless device in a cell (P_{EMAX}), maximum transmit power of the wireless device in the sidelink (P_{MAX, SL}), and/or a power class of the wireless device in sidelink (P_{PowerClass, SL}).

Certain embodiments further comprise providing the wireless device with information indicating for how long at least one of the one or more parameters remains valid after the wireless device exits network coverage.

Certain embodiments may provide one or more of the following technical advantage(s). As an example, certain embodiments reduce the impact on cellular network and cellular UEs due to sidelink operation when the transmit power of the SL UE is higher than the cellular UEs. As another example, certain embodiments define the UE behavior when moving from out-of-coverage to in-coverage or from partial-coverage to in-coverage when there is a difference in transmit power between the SL and the maximum transmit power allowed in the cell for Uu (WAN/cellular) operation. As another example, certain embodiments enable the SL UE in out-of-coverage or in partial coverage to early detect the in-coverage and continue SL operation with reduced maximum SL transmit power. This in turn extends the SL operation in the out-of-coverage.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of SL communication in a network in accordance with some embodiments.

FIG. 2 illustrates an example of SL operation of a UE in in-coverage and out-of-coverage zones in accordance with certain embodiments.

FIG. 3 illustrates an example of SL operation of a UE coexisting with different power class Uu UE in different zones in accordance with certain embodiments.

FIG. 4 illustrates an example of changing SL transmit power change of a UE in relation with the S criterion evaluation in accordance with certain embodiments.

FIG. 5 illustrates a wireless network in accordance with some embodiments. FIG. 6 illustrates a UE in accordance with some embodiments.

FIG. 7 illustrates a virtualization environment in accordance with some embodiments.

FIG. 8 illustrates a telecommunication network connected via an intermediate network to a host computer in accordance with some embodiments.

FIG. 9 illustrates a host computer communicating via a base station with a user equipment over a partially wireless connection in accordance with some embodiments.

FIG. 10 illustrates methods implemented in a communication system including a host computer, a base station and a user equipment in accordance with some embodiments.

FIG. 11 illustrates methods implemented in a communication system including a host computer, a base station and a user equipment in accordance with some embodiments.

FIG. 12 illustrates methods implemented in a communication system including a host computer, a base station and a user equipment in accordance with some embodiments.

FIG. 13 illustrates methods implemented in a communication system including a host computer, a base station and a user equipment in accordance with some embodiments.

FIGS. 14-18 illustrate methods in accordance with some embodiments.

FIG. 19 illustrates a virtualization apparatus in accordance with some embodiments.

FIG. 20 illustrates an example of a method performed by a wireless device in accordance with certain embodiments.

FIG. 21 illustrates an example of a method performed by a network node in accordance with certain embodiments.

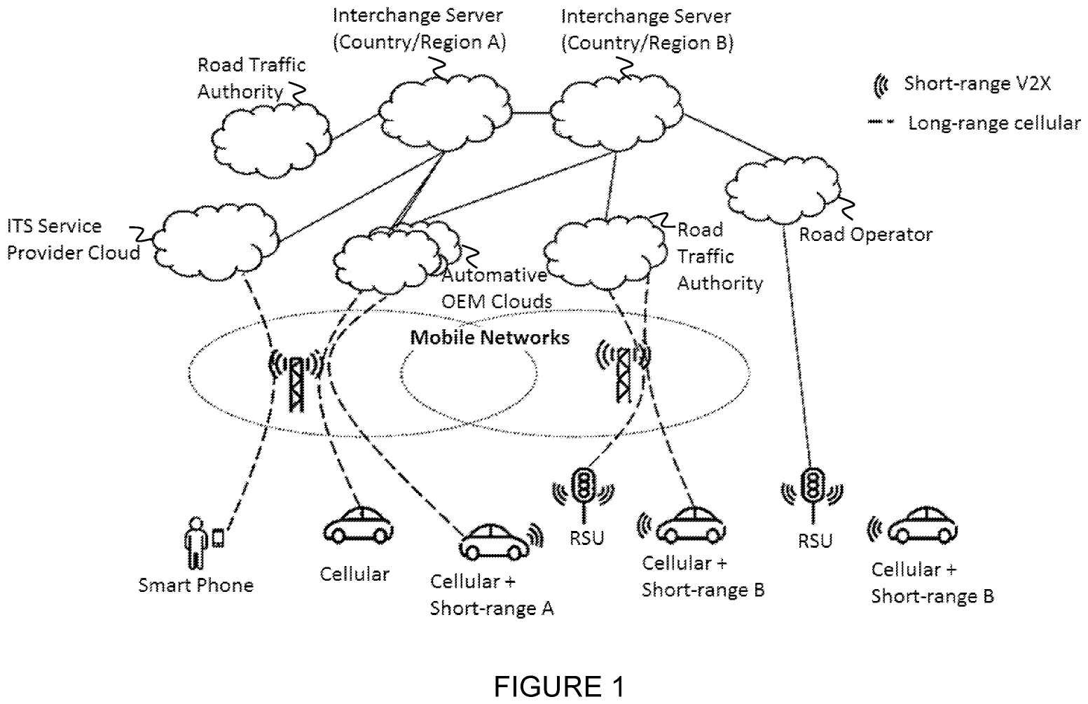

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise. any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

### Scenario and Terminologies

Certain embodiments encompass a scenario where a first UE (UE1) is served by a first cell (cell1). The UE1 is further configured to communicate with at least one another UE, a second UE (UE2), on sidelink resources. UE1 and UE2 are capable of SL operation. Examples of SL operation are transmission of SL signals by UE1, reception of SL signals at UE1 from UE2, etc.

To enable UL and SL operations, UE1 is further configured with one or more sidelink (SL) resources and one or more uplink resources. At least one SL resource and at least one UL resources are time multiplexed with each other on the same carrier frequency (F1). For example, at least one of the SL resource can be a SL time resource and also at least one of the UL resource can be an UL time resource. Examples of time resources are symbol, slot, subframe, frame, etc. The UE transmits uplink signals on one or more UL resources to at least cell1, i.e., the serving cell. The UE transmits and/or receive SL signals on one or more SL resources to at least UE2. Examples of UL signals are sounding reference signals (SRS), DMRS, physical uplink control channel (PUCCH), physical uplink shared channel (PUSCH), random access channel (RACH), etc. Examples of SL signals are DMRS, PSCCH, PSSCH, etc

The UE operation on cellular network is also called as Uu operation, wireless access network (WAN) operation. The radio link between UE and the network node (e.g., base station) may be referred to as a Uu link, Uu interface, WAN link, WAN interface, cellular link, cellular interface, etc.

The time multiplexing of SL and UL resources on the same carrier may also be called as the SL-UL time-multiplexed operation, shared SL-UL carrier operation, etc.

The term time resource used herein may correspond to any type of physical resource or radio resource expressed in terms of length of time. Examples of time resources are: symbol, time slot, subframe, radio frame, transmission time interval (TTI), interleaving time, etc. The term TTI used herein may correspond to any time period over which a physical channel can be encoded and optionally interleaved for transmission. The physical channel is decoded by the receiver over the same time period over which it was encoded. The TTI may also be interchangeably called as short TTI (sTTI), transmission time, slot, sub-slot, mini-slot, mini-subframe, etc.

The term time-frequency resource used herein for any radio resource defined in any time-frequency resource grid in a cell. Examples of time-frequency resource are resource block, subcarrier, resource block (RB), etc. The RB may also be interchangeably called as physical RB (PRB), virtual RB (VRB), etc.

The link or radio link over which the signals are transmitted between at least two UEs for D2D operation is called herein as the side link (SL). The signals transmitted between the UEs for D2D operation are called herein as SL signals. The term SL may also interchangeably be called as D2D link, V2X link, prose link, peer-to-peer link, PC5 link, etc. The SL signals may also interchangeably be called as V2X signals, D2D signals, prose signals, PC5 signals, peer-to-peer signals etc. The transmission of signals between at least two D2D UEs is called as sidelink operation, which may comprise transmission and/or reception of SL signals. The term SL operation may also be interchangeably called as SL communication, D2D communication, V2X communication, D2D operation, V2X operation, prose communication, ProSe (proximity services) operation, etc.

The term in coverage (IC) used herein comprises a scenario in which the UE is under the full coverage of one or more network nodes, such as a serving cell. For example, if the UE can detect at least one cell, then it is considered to be in IC. In another example, if the UE can detect at least one cell on a carrier on which the UE is configured to perform sidelink operation, then the UE is considered to be in IC. In another example, if the UE detects at least one cell on the frequency which UE is configured to perform sidelink operation on fulfilling the S criterion, then the UE considers itself to be in-coverage for sidelink operation on that frequency. The UE in IC is able to receive signals from and/or transmit signals to at least one network node. The UE can also maintain a communication link with the network. The IC is also interchangeably called as In Network Coverage (INC).

The term partial coverage (PC) used herein comprises a scenario in which at least one of the UEs among the UEs involved in sidelink communication is under the network coverage (i.e., is IC), and at least one UE is not under network coverage (i.e., on OOC). The PC is also interchangeably called as Partial Network Coverage (PNC).

The term out-of-coverage (OOC) used herein comprises a scenario in which none of the UEs involved in sidelink communication are under network coverage. In another example, in OOC, the UE is not associated with a serving cell on any carrier. In another example, if the UE cannot detect any cell, then the UE considers itself to be in OOC. In another example, if the UE cannot detect any cell on that frequency meeting the S criterion, then the UE considers itself to be out-of-coverage for sidelink operation on that frequency. In another example, if the UE cannot detect any cell on carrier on which it is configured to perform sidelink operation, then the UE considers itself to be in OOC. The OOC is also interchangeably called as Out-Of-Network Coverage (ONC), any cell selection state, etc.

The term time advance (TA) used herein may refer to an absolute TA value, relative TA value compared to a previous TA value, a parameter which is used for deriving TA (e.g., NTA). The TA may also be referred to as UL TA as it is primarily configured for adjusting UE transmit timing for UL transmission in UL time resource. Similarly, NTA may also be referred to as UL NTA as it is primarily configured for adjusting UE transmit timing for UL transmission in UL time resource.

The term numerology used herein may refer to any parameter characterizing signal properties, for example, signal duration (e.g., slot duration, symbol duration, etc.), subcarrier spacing (SCS), cyclic prefix (CP) length of the symbol, etc.

### Group 1 Embodiments

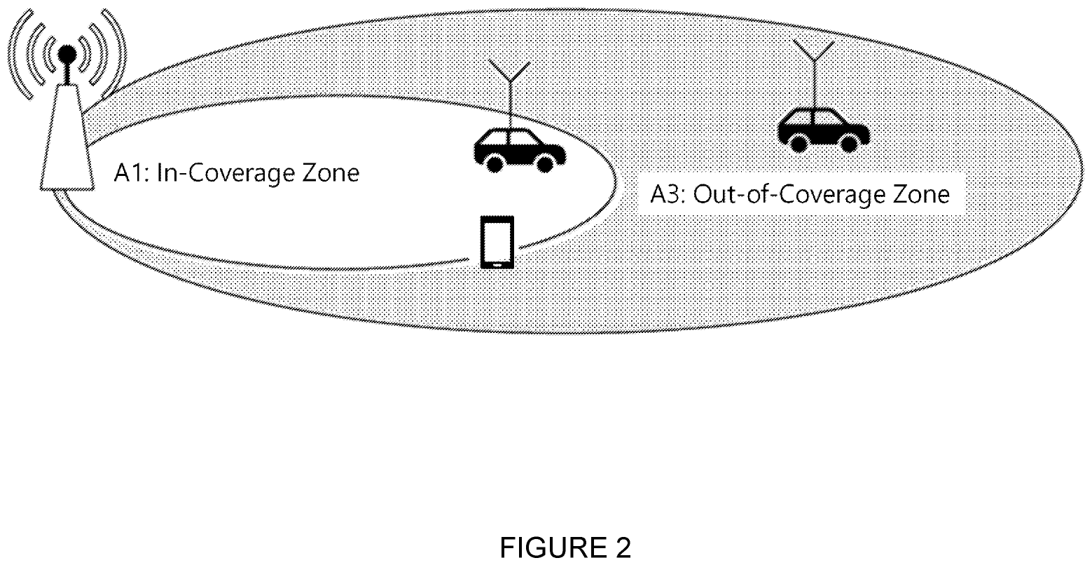

When UE is pre-configured/configured for a SL operation on a carrier, which is also used for WAN operation (e.g., NR and/or LTE Uu operation), the UE can be forbidden to perform the SL operation when UE moves into the network in-coverage zone A1 from out-of-coverage area A3 as shown in FIG. 2. Alternatively, the network (e.g., detected cell, serving cell, etc.) can schedule the UE with SL resource in mode 1 defined for SL operation to co-exist with Uu UE when SL UE moves into in-coverage zone A1 in FIG. 2.

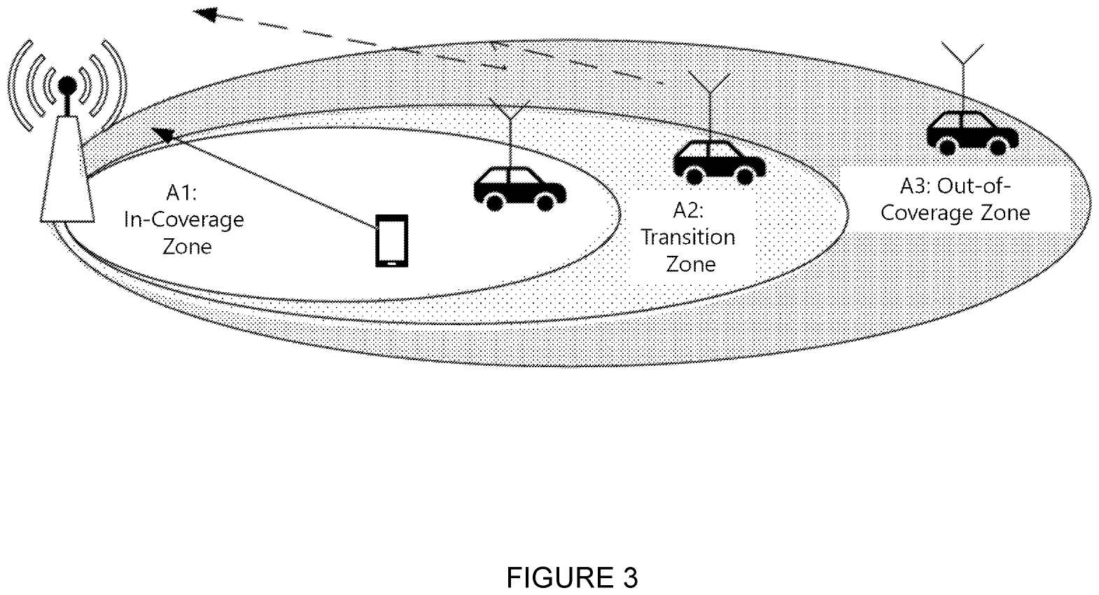

In certain scenarios, the SL UE may have a higher output power class (Ppowerclass,SL) than the network-allowed maximum output power (e.g., the maximum output power configured with the information element “p-Max” in TS 38.331 v16.3.1). At the same time, the same carrier is configured for SL UE and Uu UE operations shown in FIG. 3. In this scenario, as an example, the network (e.g., cell in zone A1) configured the maximum allowed UE transmit power to 23 dBm (e.g., corresponding to UE power class 3 (PC3)). On the other hand, the SL UE maximum power (i.e., SL UE power class) is 26 dBm in zone A2 and zone A3 (e.g., corresponding to UE power class 2 (PC2)). This example scenario is described for illustrative purpose. The embodiments are applicable to any combination of maximum allowed power in the cellular cell (e.g., p-Max) and SL UE power class (Ppowerclass, SL) (e.g., maximum power of UE for SL operation) for sidelink operation. In another example, p-Max and Ppowerclass,SL can be 20 dBm and 26 dBm, respectively. In another example, p-Max and Ppowerclass,SL can be 23 dBm and 29 dBm, respectively, and so on.

In the above scenario, the potential interference from the SL UE transmission towards the network (e.g., base station, Uu UE served by the network) will happen even before the SL UE enters zone A1 (i.e., before the SL UE enters into the cell coverage). For example, the SL UE already in zone A2 will cause the interference to the network. This is because the higher output power class SL UE (e.g., 26 dBm) has larger or more extended coverage than the coverage of the lower power class Uu UE (served by the cell in zone A1) in FIG. 3. According to certain embodiments of the present disclosure, in order to reduce such interference from the SL UE when the SL is in zone A2, the one or more in-coverage detection criteria is adapted by the UE. The in-coverage detection criteria may also be referred to as cell detection criteria, cell selection criteria, cell suitability criterion (e.g., S criteria etc.) for a cell without losing any meaning.

In one example, the cell whose cell selection criteria is assessed or determined by the UE may operate on a carrier that is pre-configured in the UE or determined based on pre-defined rules. For example, it can be the same carrier as being used by the UE for SL operation in the OOC and/or it can any carrier adjacent to that of the SL carrier and/or it can be any carrier in the same band that contains the SL carrier, and/or it can be any carrier that is at least within Y1 MHZ (e.g., 10 MHz) with respect to the SL carrier, etc. One specific example is the UE operating SL on a carrier in band n38 and there may also be one or more cells operating on the same carrier as of SL or on another carrier of band n38. In this case, for example, the SL UE maximum power is 26 dBm while the power of Uu is 23 dBm (e.g., maximum UE power class for Uu operation). Another specific example is the UE operating SL on a carrier in band n14 (UL: 788 MHz-798 MHz; DL: 758 MHz-768 MHZ) and there may also be one or more cells operating on the same carrier as the SL or on another carrier of band n14. In this case, for example, the SL UE maximum power is 31 dBm while the power of Uu is 23 dBm (e.g., maximum UE power class for Uu operation). In another example, the SL UE maximum power is 23 dBm while the power of Uu is 31 dBm (e.g., maximum UE power class for Uu operation).

One objective of adapting the criteria is to enable the SL UE to detect the cellular cell with coverage zone A1 while the SL UE is outside the coverage of the cell, such as when the SL UE is in zone A2. Another objective includes adapting the coverage zone A1 while the SL UE is outside the coverage of the cell, such as when the SL UE is in zone A2. For example, in the above scenario, the UE is operating SL in OOC and evaluates the cell selection S criteria for detecting if the UE is in-coverage. This may be realized by adapting a compensation factor or parameter which is used by the UE for detecting the cell, for example, for evaluating the cell selection criteria. An example of such parameter is Pcompensation. The following examples describe methods of adapting the Pcompensation parameter and using it for cell selection.

### EXAMPLE 1

### UE Evaluating Cell Selection Criterion Based on Adapted Pcompensation

In one exemplary solution, the UE determines Pcompensation based on a relation between P_{EMAX1} and P_{max, SL} and uses the determined Pcompensation for cell selection S criteria for detecting whether the UE is in-coverage of a cell or not.

If the UE determines that it is in in-coverage of the cell, then the UE stops at least transmission of signals on the SL. In another example, if the UE is determined to be in in-coverage of the cell, then the UE completely stops the SL operation i.e., transmission and reception of SL signals. Alternatively, the network (e.g., detected cell, serving cell, etc.) can schedule the UE with SL resource in mode 1 defined for SL operation to co-exist with Uu UEs when the SL UE moves into the in-coverage zone of the cell.

The relation between P_{EMAX1} and P_{max, SL} can be determined based on a function. Examples of functions are minimum, maximum, average, etc. One specific example of the function is given below:

Pcompensation=MIN ((P_{EMAX1}−P_{max, SL}), 0) (dB)
Where:
   P_{EMAX1}: It is the configured UE maximum output power in a cell whose S criteria is to be evaluated by the UE. No UE in the cell is allowed to transmit with power more than P_{EMAX1}. The UE may acquire P_{EMAX1} value configured in the cell, e.g., by acquiring the system information of the cell, for example, using the system information block (SIB).
   P_{max,SL}: It is the configured UE maximum output power for SL; P_{max, SL}≤P_{PowerClass, SL}. The UE transmits on SL with a transmit power that does not exceed the maximum power of P_{max,SL}. The UE may therefore transmit on SL with a power less than or equal to P_{max,SL}. For example the SL transmit power may be lower than P_{max,SL} in some scenarios, e.g., when there is not enough data, if the other UEs are in close proximity, to save the UE's battery power, etc. In some scenarios (e.g., broadcasting system information), the UE may transmit with maximum power, e.g., with P_{max,SL}. The UE may estimate its transmit power for transmitting SL signals in one or more resources autonomously, based one or more rules, which may be pre-defined, preconfigured in the UE, or configured by the network node (e.g., when the UE is in coverage).

The UE determines Srxlev (defined below) using the above derived Pcompensation and uses it to further evaluate the cell selection criterion S for a cell, as described below. If the UE determines that it meets the cell selection criterion S, then the UE stops SL operation; otherwise the UE continues the SL operation with maximum transmit power of P_{max,SL}. For example, the UE may periodically evaluate the cell selection criterion S for one or more cells, e.g., once every T1 time period or time resources. Examples of T1 are L1 number of frames, L2 DRX cycles, L3 second, etc.

In certain embodiments, the cell selection criterion S for a cell is fulfilled when the UE determines that the following condition is met by the UE:
Srxlev>0 AND Squa >0
   Srxlev is further defined as follows:

Srxlev=Qᵣₓₗₑᵥₘₑₐₛ−(Qᵣₓₗₑᵥₘᵢₙ+Qbrxlevminoffset)−P_{compensation}−Qoffsetₜₑₘₚ
Where:
   Srxlev: It is the cell selection received (RX) level value (dB)
   Squal: It is the cell selection quality value (dB)
   Qᵣₓₗₑᵥₘₑₐₛ: It is the measured cell RX level value (RSRP)
   Qᵣₓₗₑᵥₘᵢₙ is the minimum required RX level in the cell (dBm). It is signalled by the cell.
   Q_{rxlevminoffset} is the offset to the signalled Qrxlevmin. It is signalled by the cell.
   Qoffsetₜₑₘₚ: It is the offset temporarily applied to a cell. It is signalled by the cell.

### EXAMPLE 2

### UE Continues SL Operation With Reduced Maximum Transmit Power Upon Meeting Cell Selection Criterion Based on Adapted Pcompensation

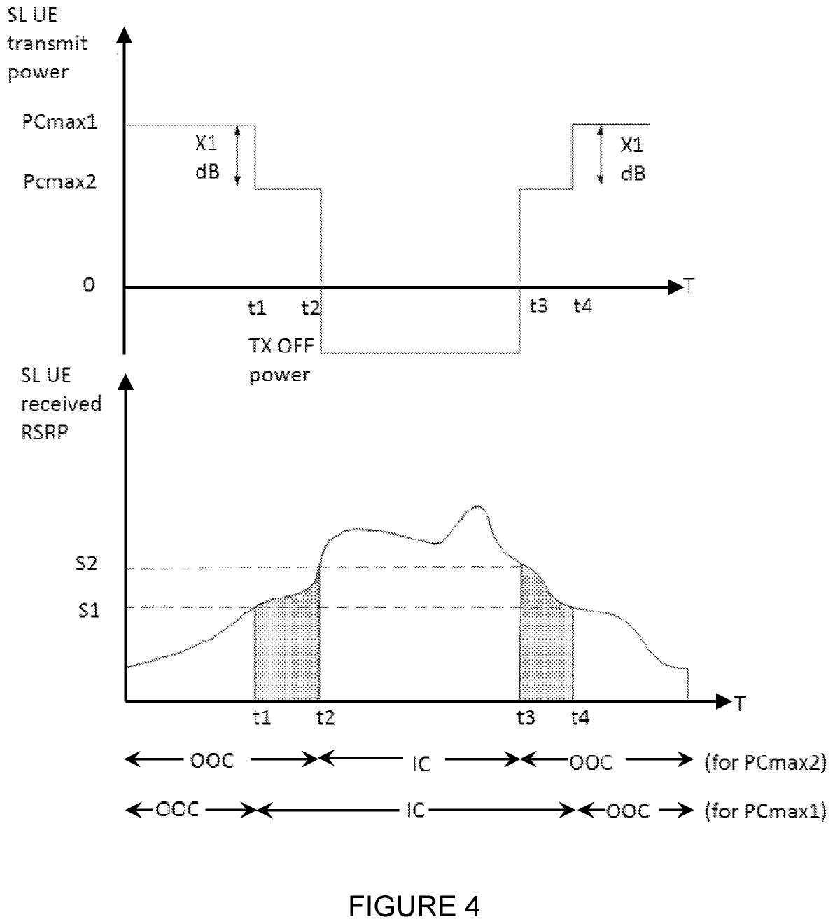

In this method, the UE operating SL in OOC also determines whether it meets the cell selection S criteria based on the solution described in example 1 above. However, in this method the UE may be configured to not stop the SL operation (or SL transmission). Instead, the UE may reduce its maximum SL transmit power by a power reduction margin (DP) and continue the SL operation using the reduced maximum SL transmit power. After reducing its SL maximum transmit power by DP, the UE may re-enter in OOC (e.g., from 23 dBm to 26 dBm) while the maximum allowed power in the cell is 23 dBm. This mechanism allows the UE to continue the SL operation with reduced transmit power even when the UE meets the cell selection criterion for a cell (i.e., reducing its SL maximum power by DP). Examples of DP are X1 dB, parameter relating the UE maximum SL transmit power and configured power in a cell, a difference between UE maximum SL transmit power and configured power in a cell (e.g., DP=(P_{max, SL}−P_{EMAX1})), etc. The reduction margin (DP) can be determined by the UE upon obtaining P_{EMAX1}, it can also be explicitly signaled by the network (via SIB or dedicated radio resource control (RRC)) or it can be predefined/preconfigured. This method is further elaborated below with FIG. 4 as one example.
Define the S criterion with RSRP threshold of S1 when P_{max, SL}>P_{EMAX1}: In this case the UE derives the Pcompensation as follows:

S1=Qᵣₓₗₑᵥₘₑₐₛ−(Qᵣₓₗₑᵥₘᵢₙ+Q_{rxlevminoffset})−P_{compensation}−Qoffsetₜₑₘₚ
Where Pcompensation=MIN ((P_{EMAX1}−P_{max, SL}), 0) (dB)
   Define the S criterion with RSRP threshold of S2 when P_{max, SL}≤P_{EMAX1}: In this case the UE derives the Pcompensation as follows:

S2=Qᵣₓₗₑᵥₘₑₐₛ−(Qᵣₓₗₑᵥₘᵢₙ+Q_{rxlevminoffset})−P_{compensation}−Qoffsetₜₑₘₚ
Where Pcompensation=MAX((P_{EMAX1}−P_{max, SL}), 0) (dB)
   As shown in FIG. 4, when SL UE RSRP≤S1 before the time t1, it is in the OOC for PCmax1 area then it continues SL operation using current maximum output power for SL, e.g., P_{max, SL}=PCmax1=P_{PowerClass, SL} (e.g., with 26 dBm). Example of SL UE RSRP is SL-RSRP.
   when (S1<SL UE RSRP≤S2) between the time t1 and t2, the UE meets the cell selection S1 criteria for a cell but not the S2 criteria, in this case, the SL UE enters into IC for PCmax1 area but still in OOC for PCmax2 and SL UE may operate SL using reduced transmit power with X1 dB power reduction relative to P_{PowerClass, SL}, e.g., P_{max, SL}=PCmax2=P_{PowerClass, SL}−X1
   when SL UE RSRP>S2 between the time t2 and t3, the UE meets the cell selection S2 criteria for a cell, in this case, SL UE should stop SL transmission. For example, SL transmission power=UE TX OFF power limit. The UE TX OFF power limit is the level at which the UE transmitter is OFF(e.g., can be regarded as the lowest UE Tx power).
   when (S1<SL UE RSRP≤S2) between the time t3 and t4, the UE meets the cell selection S1 criteria for a cell but not the S2 criteria, in this case, SL UE may operate SL using transmit power with X1 dB power reduction relative to P_{PowerClass, SL}, e.g., P_{max, SL}=PCmax2=P_{PowerClass, SL}−X1
   When SL UE RSRP≤S1 after the time t4, it is in the OOC area for PCmax1 then it continues SL operation using current maximum output power for SL, e.g., P_{max, SL}=PCmax1=P_{PowerClass, SL} (e.g., with 26 dBm)

The concept of UE continuing SL operation with reduced max Tx SL power is further elaborated with another example below:
If the UE does not meet cell selection S criteria for any cell then it continues SL operation using current maximum output power for SL e.g., P_{max, SL}=P_{PowerClass, SL} (e.g., with 26 dBm)
If the UE meets the cell selection S criteria for a cell then the UE further determines and takes one or more actions based on the determination as follows:
   Step 1: If Pcompensation<0 then the UE sets its maximum output power (P_{max, SL, new}) for SL operation as follows using P_{max,SL,old}=P_{max,SL}:

P_{max,SL,new}=P_{max,SL,old}+(P_{EMAX1}−P_{max, SL})
If the UE determines that it meets cell selection criterion S and UE may operate SL using reduced transmit power P_{max,SL,new}
   Else if (Pcompensation≥0) then the UE sets its maximum output power (P_{max, SL, new}) for SL operation as follows:
P_{max,SL,new}=P_{max,SL,old}
   If the UE determines that it meets cell selection criterion S as described above (in example 1) then the UE stops the SL operation
Else if the UE does not meet cell selection criterion S then the UE continues the SL operation using P_{max,SL}=P_{max,SL,new}
   Step 2: go to step 1 and UE further evaluates S criteria using current P_{max,SL} (e.g., using new acquired system parameter such as P_{EMAX1} of a detected cell).

### Where:

Pcompensation is as determined in example 1 in the first embodiment.
P_{max,SL,old} is the UE's maximum output power for SL (e.g., configured for the UE) being used by the UE when the UE evaluates the cell selection criteria S.

In the above example the UE may adapt its P_{max,SL} (e.g., reduce by certain margin) until for example the parameter Pcompensation≥0.

### EXAMPLE 3

### UE Stopping SL Operation Based on Additional Conditions

In a third example, the UE may be configured to not immediately stop the SL operation when one or more conditions for stopping SL operation (e.g., when S criteria is met) in example 1 or 2 described above is met. Instead, the UE may further check one or more additional conditions and, when the one or more additional conditions are met, then the UE stops the SL operation; otherwise it continues the SL operation. Examples of one or more additional conditions are given below:

In one example whether the UE stops operating SL signals or operating SL signals using reduced transmit power depends on whether it detects any SL synchronization signals (SLSS).

It is expected that if SLSS is detected, then it is an indication that the UE has detected other SL UEs that are outside of network coverage. If it has not detected SLSS, then it is an indication that this UE and other SL UEs are operating under network coverage where they are not always required to transmit SLSS. In the former case, the UE may operate using its maximum power for operating the SL signals while in the latter case it may stop operating SL signals, or it may operate SL signals using reduced power.

In other example, the SL UE, upon detecting presence of cellular cell, enters into a low activity state, e.g., DRX mode. Examples of DRX modes are common DRX mode, initial DRX mode, and UE specific DRX mode. Examples of presence of cellular cell comprises detecting of cellular synchronization signals, detecting interference from other Uu UEs, detecting increased energy level (e.g., power spectral density (PSD) above a certain threshold), etc. The motivation for entering a DRX mode for SL upon detecting presence of cellular cell is to proactively avoid interference to other co-existing Uu UEs. The UE may remain in the DRX mode for a certain time period, e.g., until UE has read the system information indicating the maximum allowed power it shall use for sidelink when operating in that cell.

### Group 2 Embodiments: UE Adapting SL Operation Based on Power Class Assistance Information From Another UE

As an embodiment, a SL capable UE (e.g., UE1) in A1 or A2 coverage zone as shown in FIG. 3 is configured to signal information on the assistance of SL power class configuration in its serving cells to its neighbor SL capable UEs (e.g., UE2). The signaled information by UE1 to other UEs (e.g., UE2) may be called herein as power class assistance information, or simply “assistance information,” etc. The UE (e.g., UE2), upon receiving the assistance information (e.g., from UE1), adapts one or more procedures as further described below. For example, the UE (e.g., UE2) may adapt one or more parameters (e.g., UE2's SL max Tx power) related to cell selection procedure and may use the one or more parameters to determine whether the UE meets the cell selection criteria for a cell or not. The UE may further stop SL operation or continue the SL operation based on the determination.

In one example. UE1 is in the coverage of a cell (in-coverage) and UE2 is in partial coverage with respect to the same cell. In another example. UE1 has recently (e.g., no later than last T1 time resources) moved out of the coverage of a cell (OOC with respective to the cell) and UE2 is therefore also OOC with respect to the same cell. This means in latter case, UE1 may still contain valid information about the last one or more serving cells, e.g., maximum allowed transmit power, etc. The information may remain until T2 time resources from the moment the UE1 loses the cell coverage, e.g., does not meet cell selection criteria for the cell anymore. Examples of T2 are K1 number of frames, K2 seconds, K3 DRX cycles, etc.

The power class assistance information transmitted by the SL UE (e.g., UE1) to one or more other SL UEs (e.g., UE2) may comprise at least one of the following:

Identifiers (IDs)/indices (e.g., physical cell identity (PCI), cell group identity (CGI), etc.) of the cells that are concerned

UE power classes supported in each of the concerned cell (e.g., maximum allowed transmit power, power class for certain band on which the cell operates, etc.)
Power classes supported for Uu operation in each of the concerned cell
Power classes supported for SL operation in each of the concerned cell
Maximum configured power (e.g., P_{EMAX1}) with which the UE can transmit in the concerned cell, e.g., for Uu, for SL, or for both Uu and SL operation in the cell.

The UE's (e.g., UE1) own power classes of Uu operation and/or SL operation in each of the concerned cell

Measured radio channel quality in terms of metrics such as RSRP, Reference Signal Received Quality (RSRQ), Received Signal Strength Indicator (RSSI), Signal-to-Interference Plus Noise Ratio (SINR), Signal-to-Interference Ratio (SIR), cell congestion level/load level, e.g., measured results of UE1 with respect to the concerned cell.

Preferred SL resource allocation mode in each of the concerned cell (e.g., resource allocation Mode 1 or Mode 2). Compared to Mode 2, Mode 1 gives better control to the gNB to manage the resource allocations to UEs to avoid interference (e.g., grant the UE with a proper power assignment) and resource collision. Therefore, each cell may be configured with different resource allocation Mode for SL UEs. In a cell, for a UE supporting power class mapping to the cell configuration, the UE may be configured to use resource allocation Mode 2, while for a UE supporting different power class compared to the cell configuration, the UE may be configured to use resource allocation Mode 1.

Positions or locations where the UE (e.g., UE1) locates when the UE (e.g., UE1) sends the signaling to the other UE (e.g., UE2). The location information may comprise for example geographical coordinates of the UE e.g., UE1. The UE may determine its location autonomously (e.g., based on global navigation satellite systems (GNSS), assisted GNSS, etc.) and/or by receiving location information from another node (e.g., location server).

The UE sends the above information to its neighbor SL capable UEs via at least one of the following signaling alternatives:

D2D or SL system information

discovery message

RRC signaling (Uu RRC or PC5-RRC)

Medium Access Control (MAC) Control Element (CE)

Control Physical Data Unit (PDU) of a protocol layer, such as Service Data Adaptation Protocol (SDAP), Packet Data Convergence Control (PDCP), Radio Link Control (RLC) or an adaptation layer in case of SL relay

L1 signaling (on channels such as PSSCH, PSCCH, Physical Sidelink Feedback Channel (PSFCH), etc.)

As an embodiment, whenever a UE (e.g., UE2) has received power class assistance information from a neighbor UE (e.g., UE1), the UE may perform at least one of the following actions:

Option 1: Exclude a cell for cell selection/re-selection/handover that is not able to support the UE's power classes (e.g., power class for SL operation in the cell)

Option 2: Select a cell (e.g., cell selection/re-selection/handover) to access that supports the UE's power classes (e.g., power class for SL operation in the cell)

Option 3: Select a cell for cell selection/re-selection/handover that is not able to support the UE's power classes (e.g., power class for SL operation in the cell), however, the UE changes its power class to be aligned with the cell

Option 4: Select a cell for cell selection/re-selection/handover that is not able to support the UE's power classes (e.g., power class for SL operation in the cell), the UE retains its power class, but uses resource allocation mode as indicated in the information for its subsequent transmissions in the cell

Option 5: The UE determines one or more parameters (e.g., Pcompensation parameter as described in embodiment 1) based on the received assistance information and uses the determined parameters for determining whether the UE is in-coverage of the cell or not, e.g., checks cell selection criteria as described in embodiment #1. If the UE determines that it is in in-coverage of the cell, then in one example the UE stops at least transmission of signals on the SL or both transmission and reception of signals on the SL (as described in example 1 in embodiment #1). In another example, if the UE determines that it is in in-coverage of the cell, then the UE may reduce its power by certain margin (e.g., DP) and continue the SL operation with reduced power (as described in example 2 in embodiment #1).

The option that the UE shall apply may be configured by a gNB, configured by another UE (e.g., a controlling UE), or preconfigured to the UE, depending on the embodiment.

### Group 3 Embodiments

As an embodiment, in a cell configured with SL communication and/or SL discovery, the cell/gNB signals information on allowed UE maximum transmission power for SL operation in the cell to UE:
First maximum allowed SL transmission power in mode 2 and in OOC
Second maximum allowed SL transmission power in mode 2 and in IC
Third Maximum allowed SL transmission power in mode 1 and in IC or
First maximum allowed SL transmission power and its corresponding Pcompensation
Second maximum allowed SL transmission power and its corresponding Pcompensation

Note: Separate Power classes for SL operation may be configured for UEs, compared to the power class configured for Uu.

This information could be signaled via at least one of the following signaling alternatives:

System information

Dedicated RRC signaling

MAC CE

L1 signaling (on channels such as PDCCH, Physical Downlink Shared Channel (PDSCH), etc.)

As an embodiment, in a cell configured with SL communication and/or SL discovery, a UE receives the information on allowed maximum UE transmission power for SL operation signaled by the gNB, the UE applies the received allowed maximum UE transmission power for the subsequent SL operation when the UE is in SL mode 2 operation and IC area and OOC area. In one example, the UE sets or configures its output power for SL operation equal to the first allowed maximum UE transmission power supported by the cell for SL operation in the cell (as signaled to the UE). In a second example, the UE sets or configures its output power for SL operation to the second allowed maximum UE transmission power as in example 1 only if the UE power class for SL operation is larger than the UE power class supported by the cell for SL operation in the cell; otherwise (i.e., if the UE's own power class is less than that supported in the cell) the UE does not change its maximum output power. The UE uses the configured maximum output power for doing the SL operation. The UE may also use the configured maximum output power for determining cell selection criteria (as described in embodiment 1).

In one example, the SL UE sets the Pcompensation in S criterion with the signaled Pcompensation corresponding the SL transmission maximum transmission power. Whether the SL transmission power should be reduced to another power level depends on other conditions or network signaling.

### Group 4 Embodiments

As an embodiment, for a SL capable UE, when the UE has triggered a handover, the information of UE power classes for SL operation is included in Handover Request signaling which is sent by the UE's serving cell to a target cell. Upon reception of the signaling, the target cell will check or assess or otherwise determine if the UE's power class of SL operation is aligned or related with the UE's SL power class allowed in the target cell. The target cell, based on the assessment or determination, performs one or more tasks described below. The term aligned or related may imply any of, e.g., UE's SL power class is aligned (same as) with the UE power classes of SL operation supported in the cell, UE power class of SL is not larger than the supported UE power class in the target cell, UE power class of SL is not larger than the maximum allowed UE transmit power (e.g., maximum configured power (P_{EMAX1}) for Uu and/or for SL in the target cell, etc. If the checked result is false (i.e., not aligned or not related), then the target cell may decide to reject the handover request. A failure cause indicating the reason why the handover is rejected is included in the response message sent from the target cell to the serving cell. The UE may report its power classes for SL operation to the gNB via a UE capability signaling or another RRC signaling, such as UE information assistance or measurement report signaling.

As an embodiment, the triggered handover may be a network triggered handover or a conditional HO procedure triggered handover.

As an embodiment, for a SL capable UE, when the UE has triggered a mobility procedure by itself (e.g., RRC connection reestablishment, RRC resume, etc.), the UE selects a cell to access considering whether the UE's power classes of SL operation is allowed in the cell. If the cell doesn't allow the UE's power classes of SL operation, the UE excludes the cell during the cell selection/reselection procedure.

Certain embodiments may be implemented in the context of a standard, such as TS 38.304, TS 38.331, and/or TS 38.101-1. For example, see Rel-17 Work Item on NR Sidelink Enhancement (RP-202846).

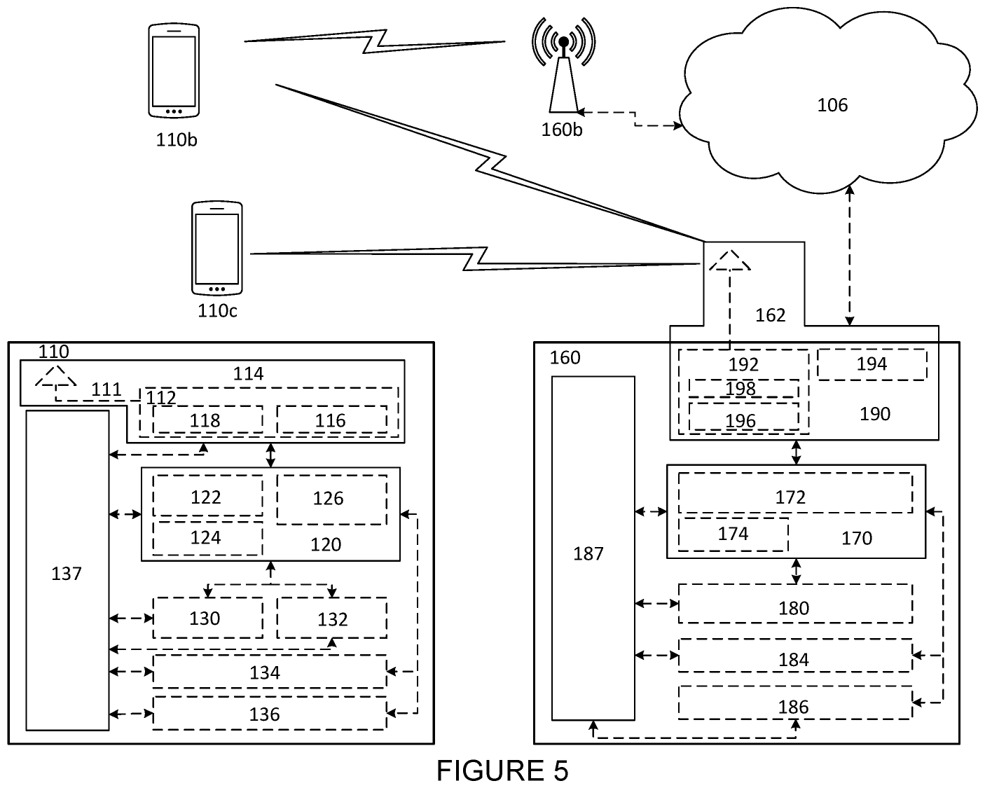

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable second generation (2G), third generation (3G), fourth generation (4G), or fifth generation (5G) standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (cNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entities (MMEs)), Operation and Maintenance (O&M) nodes, Operations Support System (OSS) nodes, Self-Optimized Network (SON) nodes, positioning nodes (e.g., Evolved-Serving Mobile Location Centre (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, Wide Code Division Multiplexing Access (WCDMA), LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IOT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, field-programmable gate array (FPGA), application-specific integrated circuit (ASIC), etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user.

A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 6, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, Universal Terrestrial Radio Access Network (UTRAN), WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

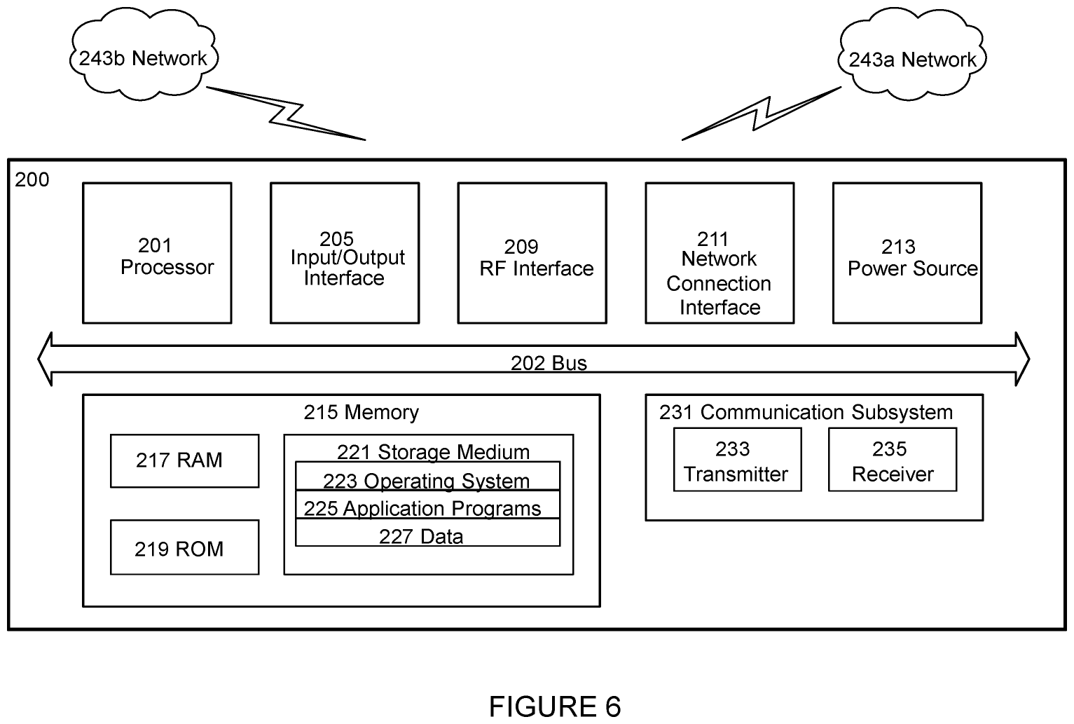

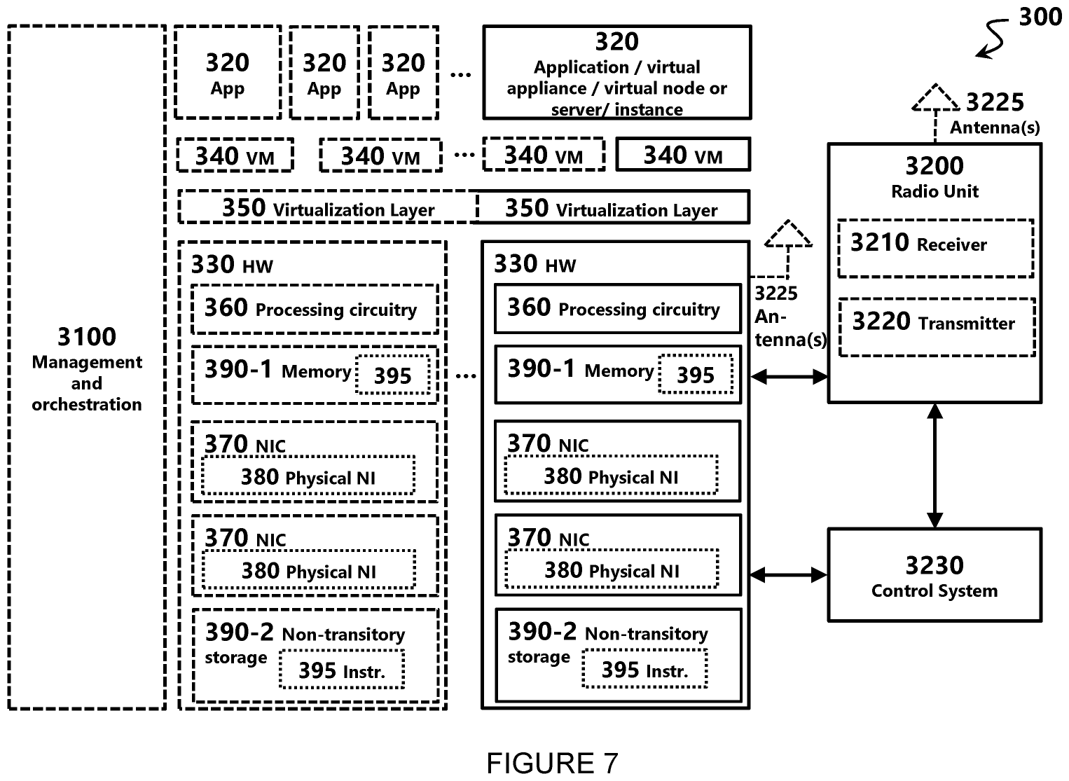

FIG. 7 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized. The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 7, hardware 330 may be a standalone network node with generic or specific components. Hardware 330 may comprise antenna 3225 and may implement some functions via virtualization. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV. Virtual Network Function (VNF) is responsible for handling specific network functions that run in one or more virtual machines 340 on top of hardware networking infrastructure 330 and corresponds to application 320 in FIG. 7.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

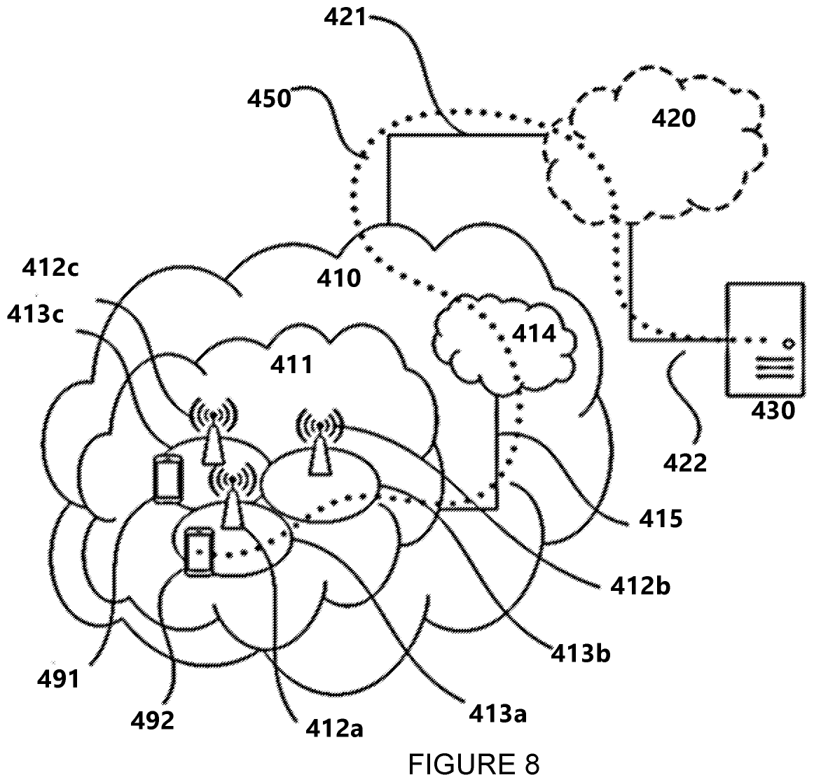

With reference to FIG. 8, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

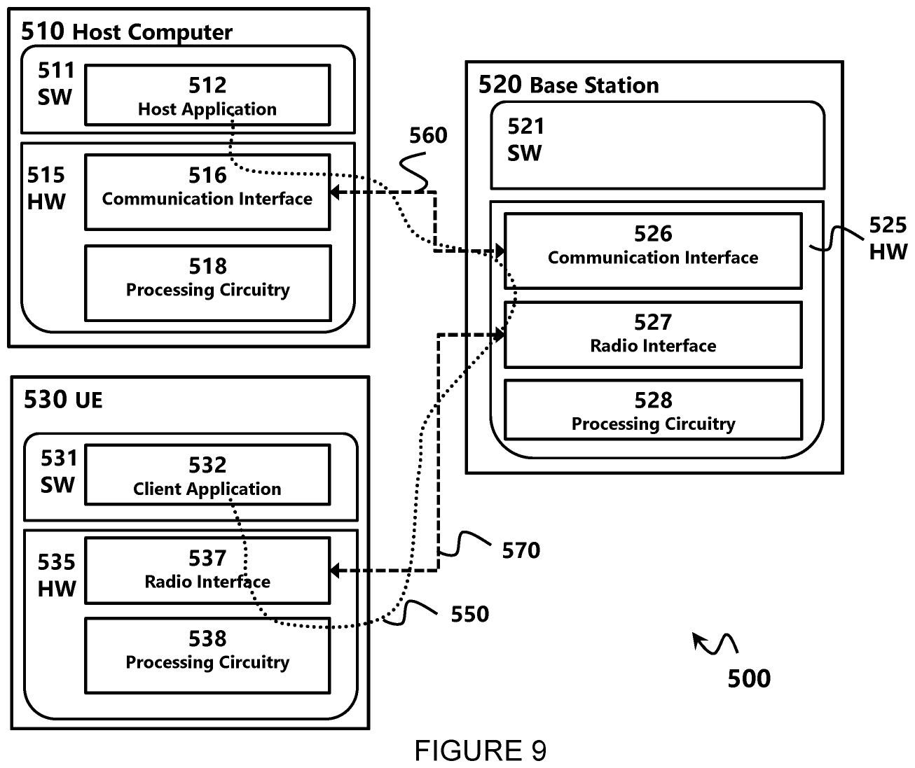

Example implementations, in accordance with an embodiment, of the UE, base station and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by base station 520. Communication interface 526 may be configured to facilitate connection 560 to host computer 510. Connection 560 may be direct or it may pass through a core network (not shown in FIG. 9) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 9 may be similar or identical to host computer 430, one of base stations 412a, 412b, 412c and one of UEs 491, 492 of FIG. 8, respectively. This is to say, the inner workings of these entities may be as shown in FIG. 9 and independently, the surrounding network topology may be that of FIG. 8. In FIG. 9. OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the power consumption and thereby provide benefits such as extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

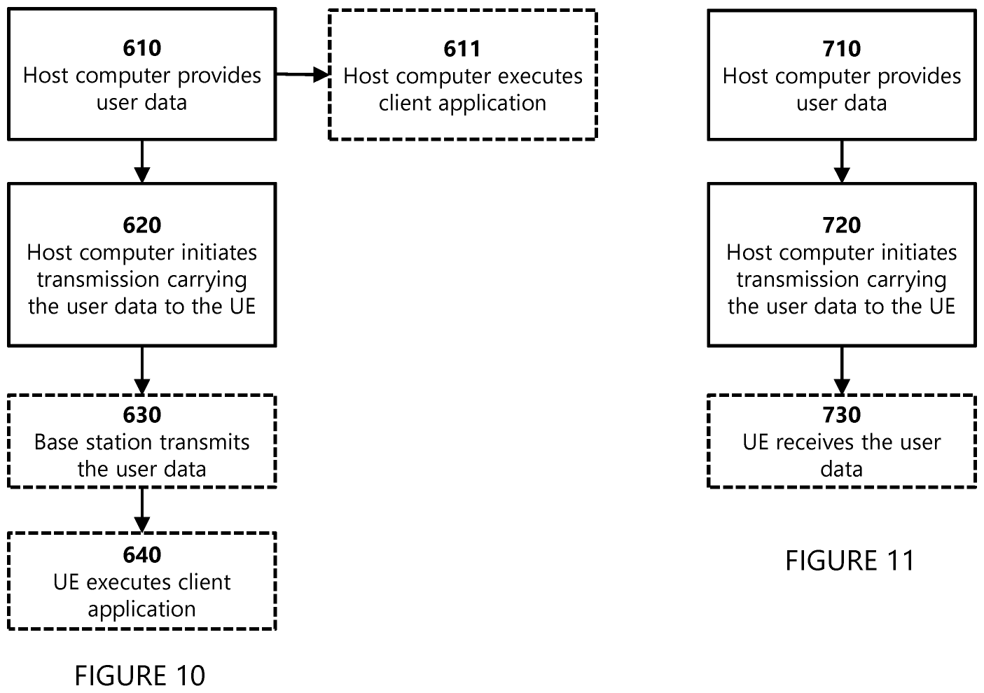

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 11 is a flowchart illustrating a method implemented in a communication system. in accordance with one embodiment. The communication system includes a host computer, a base station and a UE which may be those described with reference to FIGS. 8 and 9. For simplicity of the present disclosure, only drawing references to FIG. 11 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

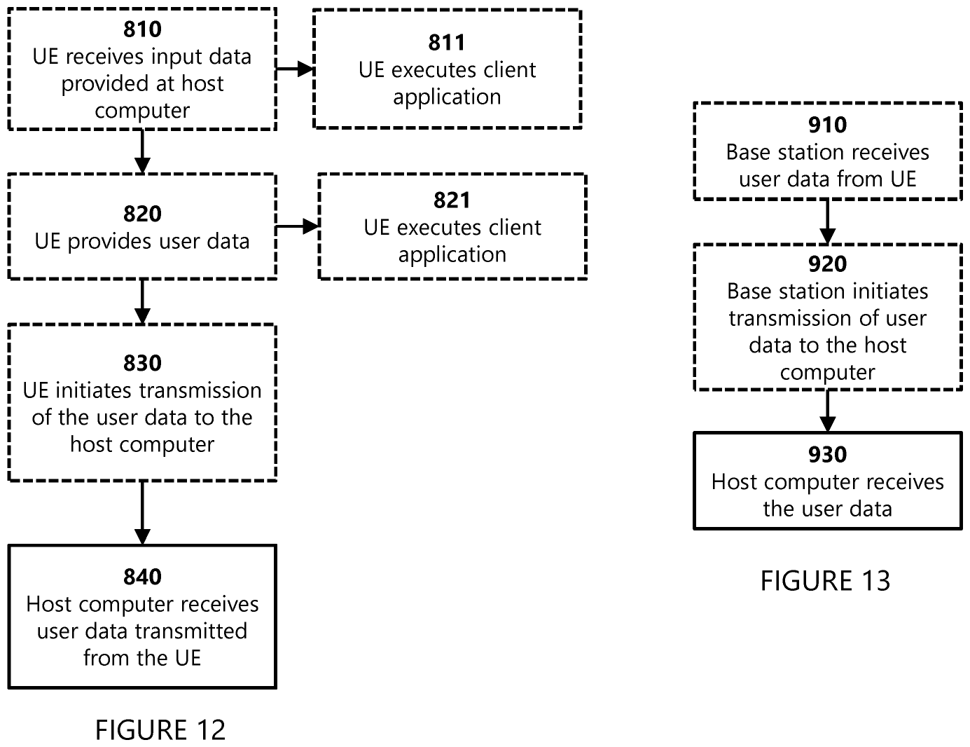

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

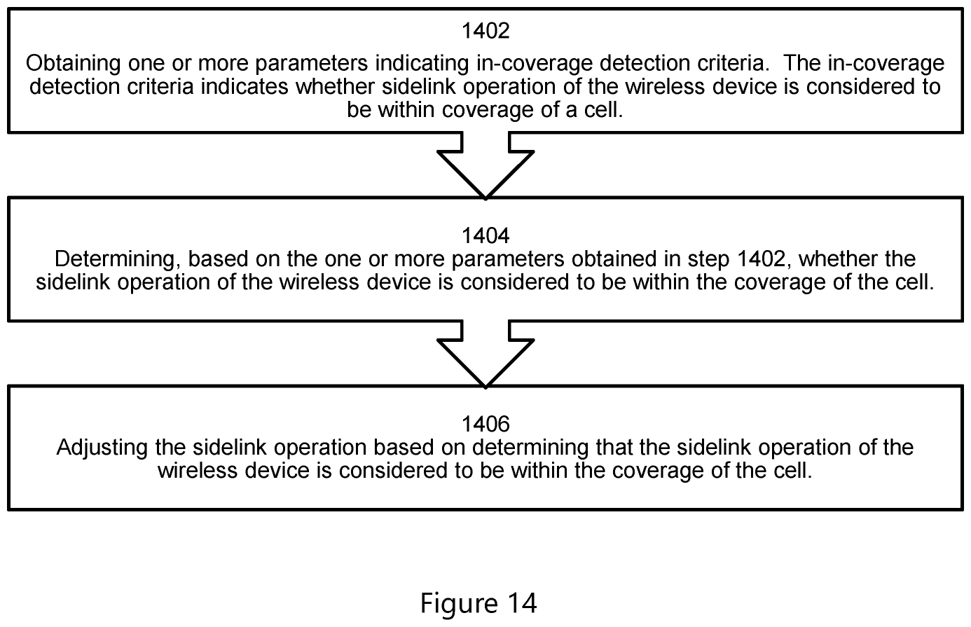

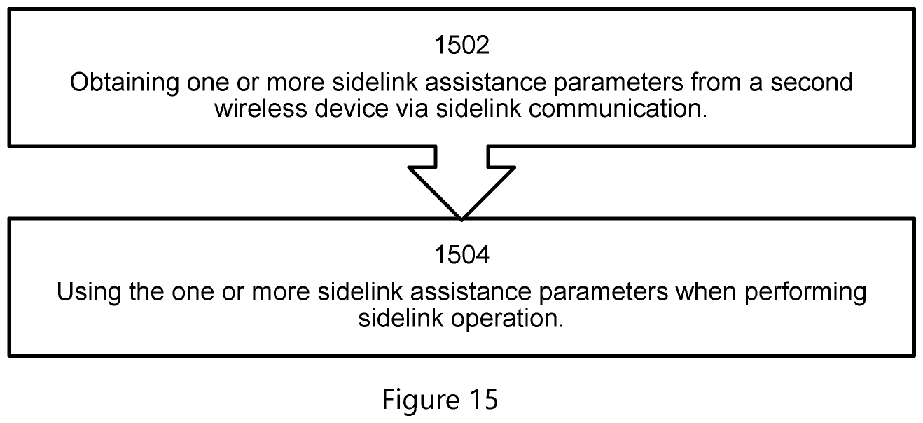

FIGS. 14 and 15 each depict a method that may be performed by a first wireless device (e.g., a wireless device 110, such as UE 200). For example, the first wireless device may comprise processing circuitry (e.g., processing circuitry 120, such as processor 201) configured to perform the method.

The method of FIG. 14 begins at step 1402 with obtaining one or more parameters indicating in-coverage detection criteria. The in-coverage detection criteria indicates whether sidelink operation of the wireless device is considered to be within coverage of a cell. As an example, certain in-coverage detection criteria may be based on signal information (e.g., RSRP, RSRQ, RSSI, SIR, SINR). As another example, the one or more parameters may comprise a compensation parameter (e.g., Pcompensation) for adjusting a cell detection parameter in order to evaluate whether the sidelink operation of the wireless device is considered to be within the coverage of the cell. The compensation value may be configured to allow the wireless device to consider itself within the coverage of the cell for purposes of sidelink operation when the wireless device is near enough to the cell that its sidelink operation could cause at least a certain amount of interference for other wireless devices that are in coverage. In certain embodiments, the wireless device could be considered in-coverage for purposes of sidelink operation while still out-of-coverage for purposes of cellular operation (e.g., if the wireless device causes interference for the cell but signals between the wireless device and the cell are not sufficient for the cell to serve the wireless device).

The one or more parameters obtained in step 1402 may be obtained from memory of the first wireless device, from a network node (e.g., the wireless device may obtain the one or more parameters while in network coverage and store the parameters for use when the wireless device goes out of coverage), or from a second wireless device via sidelink communication. In certain embodiments, the second wireless device may be in-coverage of the network (e.g., the first wireless device may be in partial coverage via sidelink communication with the second wireless device). In certain embodiments, the first wireless device and the second wireless device may both be out of coverage. The second wireless device may have been previously in-coverage of the network within a pre-determined period (recent period) such that the one or more parameters obtained from the second wireless device would be considered valid/up-to-date.

The method proceeds to step 1404 with determining, based on the one or more parameters obtained in step 1402, whether the sidelink operation of the wireless device is considered to be within the coverage of the cell. Certain embodiments determine whether the sidelink operation of the wireless device is considered to be within the coverage of the cell with respect to one or more carriers prone to interference from the sidelink operation. For example, the one or more carriers are determined to be prone to interference from the sidelink operation based on pre-defined criteria. The pre-defined criteria may indicate that one or more of the following carriers are prone to interference from the sidelink operation: a carrier that is the same as a carrier that the wireless device uses for sidelink operation when out-of-coverage; a carrier that is adjacent to the carrier that the wireless device uses for sidelink operation when out-of-coverage; a carrier that is in a same band as the carrier that the wireless device uses for sidelink operation when out-of-coverage; and/or a carrier that is within a pre-determined frequency of the carrier that the wireless device uses for sidelink operation when out-of-coverage.

The method then proceeds to step 1406 with adjusting the sidelink operation based on determining that the sidelink operation of the wireless device is considered to be within the coverage of the cell. Examples of adjusting the sidelink operation include stopping transmission of sidelink signals and/or stopping reception of sidelink signals, or reducing a maximum transmit power used for transmission of sidelink signals.

Certain embodiments may repeat step 1404 periodically and may make adjustments accordingly. For example, the wireless device may be configured to use an out-of-coverage configuration for the sidelink operation when the wireless device thinks that it is out of coverage (e.g., based on a previous/recent assessment of coverage). When the wireless device is configured to use the out-of-coverage configuration, the wireless device may periodically check to see if it has moved in-coverage. In response to determining that the wireless device has moved in-coverage, the wireless device may use an in-coverage configuration. The in-coverage configuration may stop transmission and/or reception of sidelink signals (or reduce the maximum transmit power used for transmission of the sidelink signals). The wireless device may be configured to use the in-coverage configuration for the sidelink operation when the wireless device thinks that it is in coverage (e.g., based on a previous/recent assessment of coverage). When the wireless device is configured to use the in-coverage configuration, the wireless device may periodically check to see if it has moved out of coverage. In response to determining that the wireless device is no longer considered to be within the coverage of any cell, the wireless device may switch to the out-of-coverage configuration. The out-of-coverage configuration may enable transmission and/or reception of sidelink signals (or increase the maximum transmit power used for transmission of the sidelink signals). FIG. 15 illustrates another example of a method that may be performed by a wireless device. The method begins at step 1502 with obtaining one or more sidelink assistance parameters from a second wireless device via sidelink communication. The method proceeds to step 1504 with using the one or more sidelink assistance parameters when performing sidelink operation. In certain embodiments, the sidelink assistance parameters indicate a maximum transmit power for transmitting sidelink signals when the wireless device is considered to be within coverage of a cell. In certain embodiments, the one or more sidelink assistance parameters indicate in-coverage detection criteria. The in-coverage detection criteria indicates whether sidelink operation of the wireless device is considered to be within coverage of a cell. In certain embodiments, the one or more sidelink assistance parameters indicate how to adjust the sidelink operation when the wireless device is considered to be within coverage of a cell (e.g., stop transmission of sidelink signals, stop reception of sidelink signals, or reduce a maximum transmit power for sidelink signals when the wireless device is considered to be within coverage of a cell). The second wireless device may be in-coverage of a network (such that the first wireless device is in partial coverage via sidelink communication). Or, the second wireless device may be out-of-coverage of a network (e.g., the second wireless device may have been previously/recently in-coverage of the network within a pre-determined period such that sidelink assistance parameters that the second wireless device obtained from the network and relayed to the first wireless device are considered valid/up-to-date).

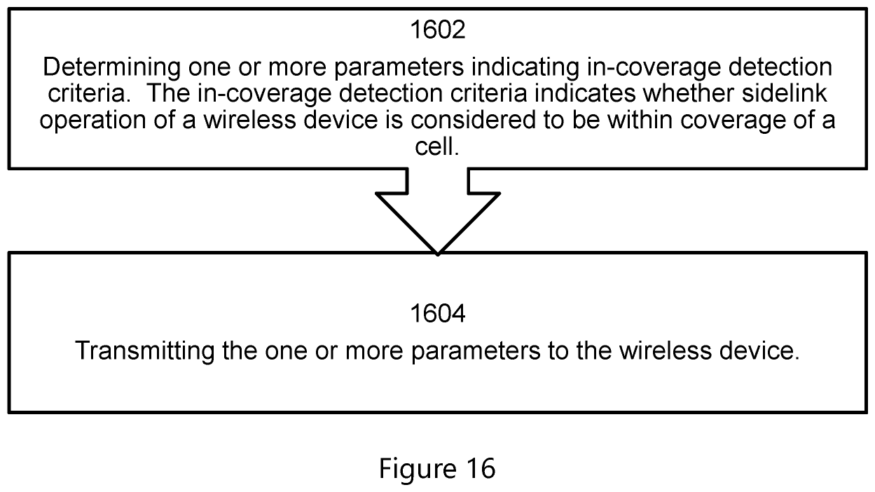

FIGS. 16, 17, and 18 each depict a method that may be performed by a network node (e.g., a network node 160). For example, the network node may comprise processing circuitry (e.g., processing circuitry 170) configured to perform the method.

The method of FIG. 16 begins at step 1602 with determining one or more parameters indicating in-coverage detection criteria. The in-coverage detection criteria indicates whether sidelink operation of a wireless device is considered to be within coverage of a cell. The method proceeds to step 1604 with transmitting the one or more parameters to the wireless device.

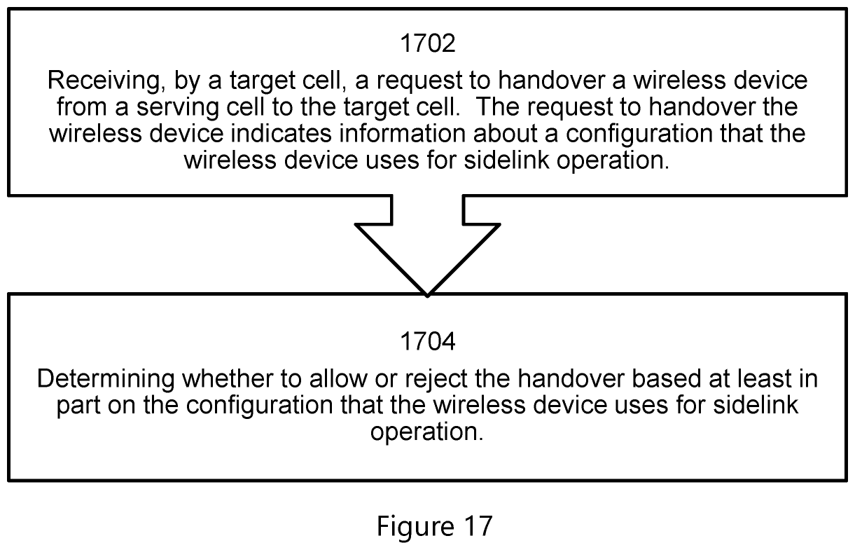

The method of FIG. 17 begins at step 1702 with receiving, by a target cell, a request to handover a wireless device from a serving cell to the target cell. The request to handover the wireless device indicates information about a configuration that the wireless device uses for sidelink operation. The method proceeds to step 1704 with determining whether to allow or reject the handover based at least in part on the configuration that the wireless device uses for sidelink operation. As an example, the request to handover the wireless device may indicate a sidelink power class associated with the wireless device, and the target cell may determine whether to allow or reject the wireless device based on the sidelink power class (e.g., based on whether the target cell permits/supports the sidelink power class). The target cell then proceeds with allowing or rejecting the handover according to the determination of step 1704.

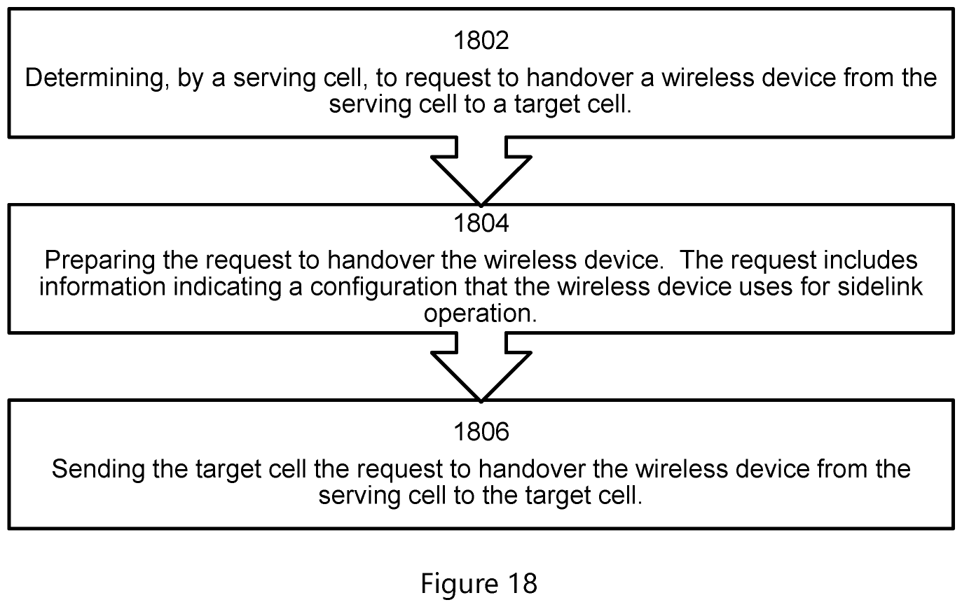

The method of FIG. 18 comprises determining, by a serving cell, to request to handover a wireless device from the serving cell to a target cell (step 1802); preparing the request to handover the wireless device (step 1804), and sending the target cell the request to handover the wireless device (step 1806). Preparing the request to handover the wireless device in step 1804 comprises including information indicating a configuration that the wireless device uses for sidelink operation. As an example, the information may indicate a sidelink power class associated with the wireless device. This information may enable the target cell to perform the method of FIG. 17, discussed above.

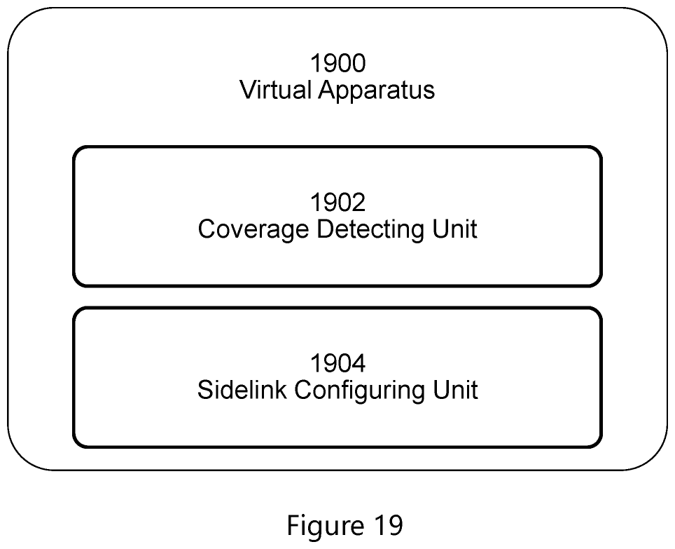

FIG. 19 illustrates a schematic block diagram of an apparatus 1900 in a wireless network (for example, the wireless network shown in FIG. 5). The apparatus may be implemented in a wireless device (e.g., wireless device 110 in FIG. 5). Apparatus 1900 is operable to carry out the example method described with reference to FIG. 14 and possibly any other processes or methods disclosed herein. It is also to be understood that the method of FIG. 14 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause coverage detecting unit 1902, sidelink configuring unit 1904, and any other suitable units of apparatus 1900 to perform corresponding functions according one or more embodiments of the present disclosure.

As illustrated in FIG. 19, apparatus 1900 includes coverage detecting unit 1902 and sidelink configuring unit 1904. Coverage detecting unit 1902 is configured to detect whether the wireless device is considered to be in coverage of any cell for purposes of sidelink operation. Sidelink configuring unit 1904 is configured to control sidelink operation. For example, sidelink configuring unit 1904 may adjust sidelink operation in response to coverage detecting unit 1902 determining that the wireless device is considered to be in-coverage or out-of-coverage for purposes of sidelink operation. If the wireless device is considered to be in-coverage, sidelink configuration unit 1904 may adjust sidelink operation to reduce or prevent interference associated with the sidelink operation.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

### Embodiments

### Group A Embodiments

1. A method performed by a wireless device, the method comprising:
   obtaining one or more parameters indicating in-coverage detection criteria, the in-coverage detection criteria indicating whether sidelink operation of the wireless device is considered to be within coverage of a cell;
determining, based on the one or more parameters, whether the sidelink operation of the wireless device is considered to be within the coverage of the cell; and
   adjusting the sidelink operation based on determining that the sidelink operation of the wireless device is considered to be within the coverage of the cell.
2. The method of embodiment 1, wherein:
   the wireless device is configured with a cell detection parameter for detecting the cell; and
   the one or more parameters comprise a compensation parameter for adjusting the cell detection parameter in order to evaluate whether the sidelink operation of the wireless device is considered to be within the coverage of the cell.
3. The method of any of embodiments 1-2, wherein adjusting the sidelink operation comprises stopping transmission of sidelink signals.
4. The method of any of embodiments 1-3, wherein adjusting the sidelink operation comprises stopping reception of sidelink signals.
5. The method of any of embodiments 1-2, wherein adjusting the sidelink operation comprises reducing a maximum transmit power used for transmission of sidelink signals.
6. The method of any of embodiments 1-5, wherein determining whether the sidelink operation of the wireless device is considered to be within the coverage of the cell is performed periodically.
7. The method of any of embodiments 1-6, wherein determining whether the sidelink operation of the wireless device is considered to be within the coverage of the cell is performed when the wireless device is configured to use an out-of-coverage configuration for the sidelink operation.
8. The method of any of embodiments 1-7, wherein determining whether the sidelink operation of the wireless device is considered to be within the coverage of the cell is performed when the wireless device is configured to use an in-coverage configuration for the sidelink operation.
9. The method of any of embodiments 1-8, further comprising, in response to determining that the wireless device is no longer considered to be within the coverage of any cell, performing one or more of the following:
   enabling transmission of sidelink signals;
   enabling reception of sidelink signals; and/or
   increasing a maximum transmit power used for transmission of the sidelink signals.
10. The method of any of embodiments 1-9, wherein determining whether the sidelink operation of the wireless device is considered to be within the coverage of the cell is performed with respect to one or more carriers prone to interference from the sidelink operation.
11. The method of embodiment 10, wherein the one or more carriers are determined to be prone to interference from the sidelink operation based on pre-defined criteria, the pre-defined criteria indicating that one or more of the following carriers are prone to interference from the sidelink operation:
   a carrier that is the same as a carrier that the wireless device uses for sidelink operation when out-of-coverage;
   a carrier that is adjacent to the carrier that the wireless device uses for sidelink operation when out-of-coverage;
   a carrier that is in a same band as the carrier that the wireless device uses for sidelink operation when out-of-coverage; and/or
   a carrier that is within a pre-determined frequency of the carrier that the wireless device uses for sidelink operation when out-of-coverage.
12. The method of any of embodiments 1-11, wherein at least one of the one or more parameters indicating in-coverage detection criteria is based on at least one of the following values: reference signal received power (RSRP), reference signal received quality (RSRQ), received signal strength indicator (RSSI), signal-to-interference ratio (SIR), or signal-to-interference plus noise ratio (SINR).
13. The method of any of embodiments 1-12, wherein at least one of the one or more parameters is obtained from memory of the wireless device.
14. The method of any of embodiments 1-13, wherein at least one of the one or more parameters is obtained from a network node.
15. The method of any of embodiments 1-14, wherein at least one of the one or more parameters is obtained from a second wireless device via the sidelink operation.
16. The method of embodiment 15, wherein the second wireless device is in-coverage of a network.
17. The method of embodiment 15, wherein the second wireless device is out-of-coverage of a network but was previously in-coverage of the network within a pre-determined period.
18. A method performed by a wireless device, the method comprising:
   obtaining one or more sidelink assistance parameters from a second wireless device via sidelink communication; and
   using the one or more sidelink assistance parameters when performing sidelink operation.
19. The method of embodiment 18, wherein the one or more sidelink assistance parameters indicate a maximum transmit power for transmitting sidelink signals when the wireless device is considered to be within coverage of a cell.
20. The method of any of embodiments 18-19, wherein the one or more sidelink assistance parameters indicate in-coverage detection criteria, the in-coverage detection criteria indicating whether sidelink operation of the wireless device is considered to be within coverage of a cell.
21. The method of any of embodiments 18-20, wherein the one or more sidelink assistance parameters indicate how to adjust the sidelink operation when the wireless device is considered to be within coverage of a cell.
22. The method of embodiment 21, wherein the one or more sidelink assistance parameters indicate to stop transmission of sidelink signals, stop reception of sidelink signals, or reduce a maximum transmit power for sidelink signals when the wireless device is considered to be within coverage of a cell.
23. The method of any of embodiments 18-22, wherein the second wireless device is in-coverage of a network.
24. The method of any of embodiments 18-23, wherein the second wireless device is out-of-coverage of a network but was previously in-coverage of the network within a pre-determined period.
25. The method of any of the previous embodiments, further comprising:
   providing user data; and
   forwarding the user data to a host computer via the transmission to the base station.

### Group B Embodiments

26. A method performed by a base station, the method comprising:
   transmitting one or more parameters indicating in-coverage detection criteria, the in-coverage detection criteria indicating whether sidelink operation of a wireless device is considered to be within coverage of a cell.
27. The method of embodiment 26, further comprising: determining the one or more parameters indicating in-coverage detection criteria to transmit to the wireless device.
28. The method of any of embodiments 26-27, wherein the one or more parameters comprise a compensation parameter for adjusting a cell detection parameter that the wireless device is configured to use to detect the cell.
29. The method of any of embodiments 26-28, wherein the one or more parameters indicate that the wireless device is to stop transmission of sidelink signals when the wireless device is considered to be within coverage of the cell.
30. The method of any of embodiments 26-29, wherein the one or more parameters indicate that the wireless device is to stop reception of sidelink signals when the wireless device is considered to be within coverage of the cell.
31. The method of any of embodiments 26-30, wherein the one or more parameters indicate that the wireless device is to reduce a maximum transmit power used for transmission of sidelink signals when the wireless device is considered to be within coverage of the cell.
32. The method of any of embodiments 26-31, wherein the one or more parameters indicate that the wireless device is to periodically determine whether the sidelink operation of the wireless device is considered to be within the coverage of the cell.
33. The method of any of embodiments 26-32, wherein at least one of the one or more parameters indicates that the wireless device is to determine whether the sidelink operation of the wireless device is considered to be within the coverage of the cell with respect to at least one of the following carriers:
   a carrier that is the same as a carrier that the wireless device uses for sidelink operation when out-of-coverage;
   a carrier that is adjacent to the carrier that the wireless device uses for sidelink operation when out-of-coverage;
   a carrier that is in a same band as the carrier that the wireless device uses for sidelink operation when out-of-coverage; and/or
   a carrier that is within a pre-determined frequency of the carrier that the wireless device uses for sidelink operation when out-of-coverage.
34. The method of any of embodiments 26-33, wherein at least one of the one or more parameters indicating in-coverage detection criteria is based on at least one of the following values: reference signal received power (RSRP), reference signal received quality (RSRQ), received signal strength indicator (RSSI), signal-to-interference ratio (SIR), or signal-to-interference plus noise ratio (SINR).
35. The method of any of embodiments 26-34, further comprising:
   providing the wireless device with information indicating for how long at least one of the one or more parameters remains valid after the wireless device exits network coverage.
36. A method performed by a base station, the method comprising:
   receiving, by a target cell, a request to handover a wireless device from a serving cell to the target cell, wherein the request to handover the wireless device indicates information about a configuration that the wireless device uses for sidelink operation; and
   determining whether to allow or reject the handover based at least in part on the configuration that the wireless device uses for sidelink operation.
37. A method performed by a base station, the method comprising:
   determining, by a serving cell, to request to handover a wireless device from the serving cell to a target cell;
   preparing the request to handover the wireless device, wherein preparing the request to handover the wireless device comprises including information indicating a configuration that the wireless device uses for sidelink operation; and
   sending the target cell the request to handover the wireless device.
38. The method of any of the previous embodiments, further comprising:
   obtaining user data; and
   forwarding the user data to a host computer or a wireless device.

### Group C Embodiments

39. A wireless device, the wireless device comprising:
   processing circuitry configured to perform any of the steps of any of the Group A embodiments; and
   power supply circuitry configured to supply power to the wireless device.
40. A base station, the base station comprising:
   processing circuitry configured to perform any of the steps of any of the Group B embodiments;
   power supply circuitry configured to supply power to the base station.
41. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
42. A computer program, the computer program comprising instructions which when executed on a computer perform any of the steps of any of the Group A embodiments.
43. A computer program product comprising a computer program, the computer program comprising instructions which when executed on a computer perform any of the steps of any of the Group A embodiments.
44. A non-transitory computer-readable storage medium or carrier comprising a computer program, the computer program comprising instructions which when executed on a computer perform any of the steps of any of the Group A embodiments.
45. A computer program, the computer program comprising instructions which when executed on a computer perform any of the steps of any of the Group B embodiments.
46. A computer program product comprising a computer program, the computer program comprising instructions which when executed on a computer perform any of the steps of any of the Group B embodiments.
47. A non-transitory computer-readable storage medium or carrier comprising a computer program, the computer program comprising instructions which when executed on a computer perform any of the steps of any of the Group B embodiments.
48. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
49. The communication system of the pervious embodiment further including the base station.
50. The communication system of the previous 2 embodiments, further including the UE, wherein the UE is configured to communicate with the base station.
51. The communication system of the previous 3 embodiments, wherein:
   the processing circuitry of the host computer is configured to execute a host application, thereby providing the user data; and
   the UE comprises processing circuitry configured to execute a client application associated with the host application.
52. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
53. The method of the previous embodiment, further comprising, at the base station, transmitting the user data.
54. The method of the previous 2 embodiments, wherein the user data is provided at the host computer by executing a host application, the method further comprising, at the UE, executing a client application associated with the host application.
55. A user equipment (UE) configured to communicate with a base station, the UE comprising a radio interface and processing circuitry configured to performs the of the previous 3 embodiments.
56. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
57. The communication system of the previous embodiment, wherein the cellular network further includes a base station configured to communicate with the UE.
58. The communication system of the previous 2 embodiments, wherein:
   the processing circuitry of the host computer is configured to execute a host application, thereby providing the user data; and
   the UE's processing circuitry is configured to execute a client application associated with the host application.
59. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
60. The method of the previous embodiment, further comprising at the UE, receiving the user data from the base station.
61. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
62. The communication system of the previous embodiment, further including the UE.
63. The communication system of the previous 2 embodiments, further including the base station, wherein the base station comprises a radio interface configured to communicate with the UE and a communication interface configured to forward to the host computer the user data carried by a transmission from the UE to the base station.
64. The communication system of the previous 3 embodiments, wherein:
   the processing circuitry of the host computer is configured to execute a host application; and
   the UE's processing circuitry is configured to execute a client application associated with the host application, thereby providing the user data.
65. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
66. A method implemented in a communication system including a host computer, a base station and a user equipment (UE), the method comprising:
   at the host computer, receiving user data transmitted to the base station from the UE, wherein the UE performs any of the steps of any of the Group A embodiments.
67. The method of the previous embodiment, further comprising, at the UE, providing the user data to the base station.
68. The method of the previous 2 embodiments, further comprising:
   at the UE, executing a client application, thereby providing the user data to be transmitted; and
   at the host computer, executing a host application associated with the client application.
69. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
70. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
71. The communication system of the previous embodiment further including the base station.
72. The communication system of the previous 2 embodiments, further including the UE, wherein the UE is configured to communicate with the base station.
73. The communication system of the previous 3 embodiments, wherein:
   the processing circuitry of the host computer is configured to execute a host application;
   the UE is configured to execute a client application associated with the host application, thereby providing the user data to be received by the host computer.
74. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
75. The method of the previous embodiment, further comprising at the base station, receiving the user data from the UE.
76. The method of the previous 2 embodiments, further comprising at the base station, initiating a transmission of the received user data to the host computer.

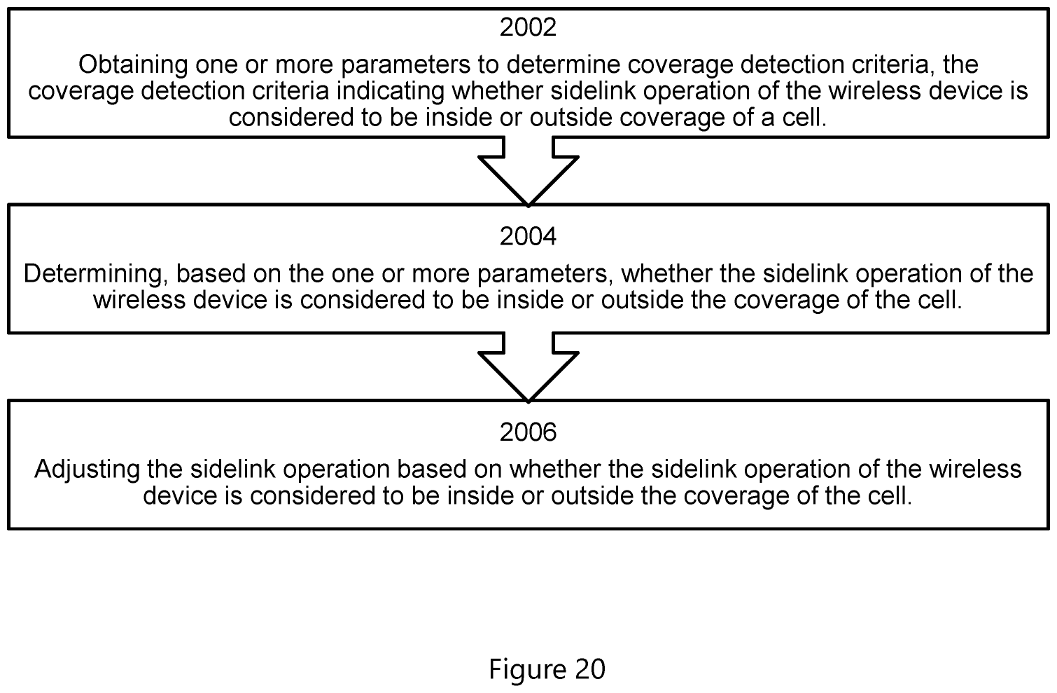

FIG. 20 illustrates an example of a method performed by a wireless device in accordance with certain embodiments. In an embodiment, the method of FIG. 20 may be performed by a wireless device 110. For example, wireless device 110 may comprise processing circuitry 120 configured to perform the steps of the method. In an embodiment, the processing circuitry 120 may execute instructions of a computer program that cause wireless device 110 to perform the method. In an embodiment, the wireless device that performs the method of FIG. 20 may be a user equipment 200. For example, user equipment 200 may comprise processing circuitry 201 configured to perform the steps of the method. In an embodiment, the processing circuitry 201 may execute instructions of a computer program that cause user equipment 200 to perform the method.

In certain embodiments, the method begins at step 2002 with obtaining one or more parameters to determine coverage detection criteria. The coverage detection criteria indicates whether sidelink operation of the wireless device is considered to be inside or outside coverage of a cell. For example, the one or more parameters may be obtained from memory of the wireless device, from the network node, from a second wireless device via sidelink operation, or any combination of the preceding. Thus, in certain embodiments, at least one of the one or more parameters is obtained from memory of the wireless device. In certain embodiments, at least one of the one or more parameters is obtained from a network node. A parameter may be obtained from the network node in any suitable manners, such as via System Information, dedicated RRC signaling, a MAC CE, L1 signaling (e.g., on a PDCCH or PDSCH), etc. In certain embodiments, at least one of the one or more parameters is obtained from a second wireless device via the sidelink operation. The second wireless device may be in-coverage of a network comprising the cell or, in certain embodiments, the second wireless device may be out-of-coverage of the network comprising the cell (but the second wireless device was previously in-coverage of the network within a pre-determined period). Further examples of obtaining parameters from a second wireless device are described above, for example, with respect to the heading “Group 2 Embodiments: UE adapting SL operation based on power class assistance information from another UE.”

In certain embodiments, the one or more parameters obtained in step 2002 may be associated with a formula or equation for cell selection. In certain embodiments, at least one of the one or more parameters obtained in step 2002 is based on at least one of the following values: RSRP, RSRQ, RSSI, SIR, SINR, P_{EMAX}, P_{MAX, SL}, and/or P_{PowerClass, SL}.

The method proceeds to step 2004 with determining, based on the one or more parameters obtained in step 2002, whether the sidelink operation of the wireless device is considered to be inside or outside the coverage of the cell. The step of determining whether the sidelink operation of the wireless device is considered to be inside or outside the coverage of the cell (step 2004) can be performed at any suitable time or under any suitable conditions, such as periodically, when the wireless device is configured to use an out-of-coverage configuration for the sidelink operation, or when the wireless device is configured to use an in-coverage configuration for the sidelink operation.

In certain embodiments, determining whether the sidelink operation of the wireless device is considered to be inside or outside the coverage of the cell is performed with respect to one or more carriers prone to interference from the sidelink operation. Certain embodiments determine the one or more carriers prone to interference from the sidelink operation based on pre-defined criteria. For example, the pre-defined criteria may indicate that one or more of the following carriers are prone to interference from the sidelink operation: a carrier that is the same as a carrier that the wireless device uses for sidelink operation, a carrier that is adjacent to the carrier that the wireless device uses for sidelink operation, a carrier that is in a same band as the carrier that the wireless device uses for sidelink operation, and/or a carrier that is within a pre-determined frequency of the carrier that the wireless device uses for sidelink operation.

As an example, in certain embodiments, determining whether the sidelink operation of the wireless device is considered to be inside or outside the coverage of the cell comprises determining a Pcompensation value based on the one or more parameters and determining whether the sidelink operation of the wireless device is considered to be inside or outside the coverage of the cell based on the Pcompensation value. Examples of the one or more parameters for determining the Pcompensation value may include one or more of the following: P_{EMAX}, P_{MAX, SL}, and/or P_{PowerClass, SL}. As an example, in an embodiment, Pcompensation=MIN ((P_{EMAX1}−P_{MAX, SL}), 0) (dB). In an embodiment, P_{MAX, SL}=PCmax1=P_{PowerClass, SL} (e.g., with 26 dBm) (note, power class of the sidelink parameter may be different with maximum transmit power P_{MAX, SL}).

In certain embodiments, the Pcompensation value is used to determine a signal strength threshold and determining whether the sidelink operation of the wireless device is considered to be inside or outside the coverage of the cell is based on the signal strength threshold. For example, the signal strength threshold may be a threshold used in cell selection, such as Srxlev. Certain embodiments evaluate whether the wireless device meets a cell selection criterion for the cell based on at least the signal strength threshold. Certain embodiments may also use other information, such as RxQual, when evaluating whether the wireless device meets the cell selection criterion. Certain embodiments determine whether the sidelink operation of the wireless device is considered to be inside or outside the coverage of the cell is based on whether the wireless device meets the cell selection criterion for the cell.

Further examples are described above with respect to the Group 1 Embodiments under the heading “Example 1: UE evaluating cell selection criterion based on adapted Pcompensation.”

The method proceeds to step 2006 with adjusting the sidelink operation based on whether the sidelink operation of the wireless device is considered to be inside or outside the coverage of the cell (e.g., as determined in step 2004).

In certain embodiments, adjusting the sidelink operation may comprise stopping transmission of sidelink signals, stopping reception of sidelink signals, or reducing a maximum transmit power used for transmission of sidelink signals. For example, if the sidelink operation of the wireless device is considered to be inside the coverage of the cell, such actions may reduce interference of the sidelink operation on the cell.

In certain embodiments, adjusting the sidelink operation may comprise enabling transmission of sidelink signals, enabling reception of sidelink signals, or increasing the maximum transmit power used for transmission of sidelink signals. For example, if the sidelink operation of the wireless device is considered to be outside the coverage of the cell, such actions may be taken with less risk of the sidelink operation creating interference that affects the cell. Certain embodiments take such actions if the wireless device is no longer considered to be inside the coverage of any cell.

In certain embodiments, adjusting the sidelink operation comprises switching a mode used by the wireless device. In certain embodiments, switching the mode affects whether resource allocation is controlled by a network node or autonomously by the wireless device. As an example, if the wireless device is configured in a mode where resource allocation is controlled by the network node, the wireless device may switch to a mode where resource allocation is controlled autonomously by the wireless device based on determining that the sidelink operation of the wireless device is considered to be outside the coverage of the cell. As another example, if the wireless device is configured in a mode where resource allocation is controlled autonomously by the wireless device, the wireless device may switch to a mode where resource allocation is controlled by the network node based on determining that the sidelink operation of the wireless device is considered to be inside the coverage of the cell. In certain embodiments, adjusting the sidelink operation comprises switching from Mode 1 to Mode 2 or switching from Mode 2 to Mode 1 depending on whether the sidelink operation of the wireless device is considered to be inside or outside the coverage of the cell.

Further examples of adjusting the sidelink operation of the wireless device are described above, for example, with respect to the Group 1 Embodiments under the headings “Example 2: UE continues SL operation with reduced maximum transmit power upon meeting cell selection criterion based on adapted Pcompensation” and “Example 3: UE stopping SL operation based on additional conditions.”

Further examples of parameters for determining whether the sidelink operation of the wireless device is considered to be inside or outside the coverage of the cell and/or examples of uses for those parameters are described above, for example, with respect to the Group 1, Group 2, and Group 3 embodiments.

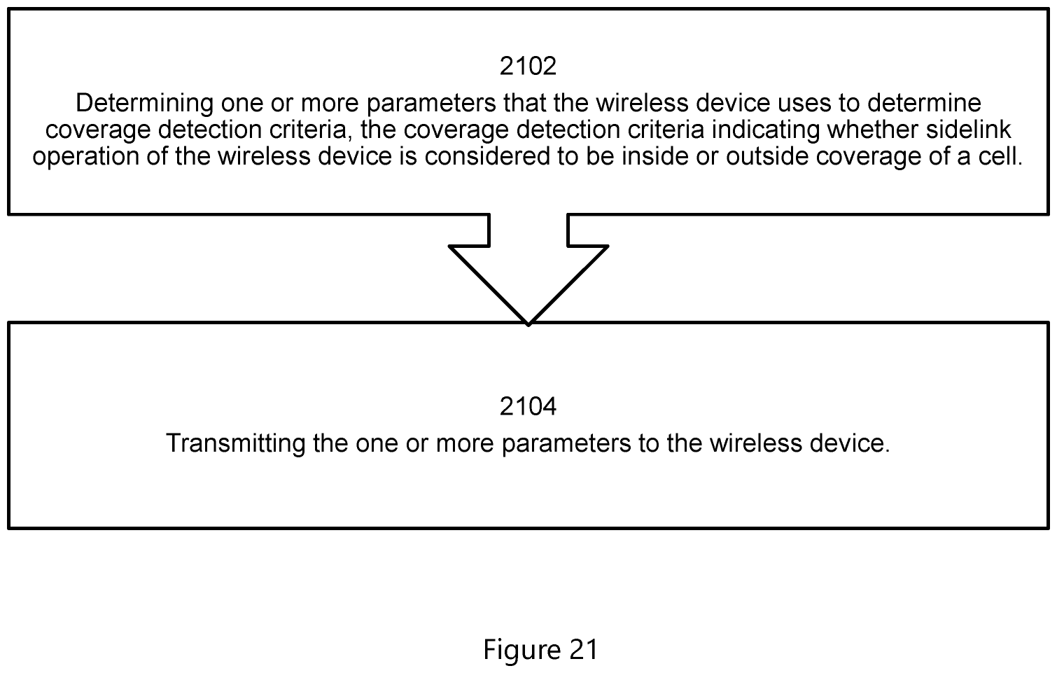

FIG. 21 illustrates an example of a method performed by a network node in accordance with certain embodiments. In an embodiment, the method of FIG. 21 may be performed by a network node 160. For example, network node 160 may comprise processing circuitry 170 configured to perform the steps of the method. In an embodiment, the processing circuitry 170 may execute instructions of a computer program that cause the network node to perform the method.

The method begins at step 2102 with determining one or more parameters to transmit to the wireless device. The one or more parameters include parameters that the wireless device uses to determine coverage detection criteria. The coverage detection criteria indicates whether sidelink operation of the wireless device is considered to be inside or outside coverage of a cell.

In certain embodiments, at least one of the one or more parameters to determine coverage detection criteria is based on at least one of the following values: RSRP, RSRQ. RSSI, SIR, SINR, P_{EMAX}, P_{MAX, SL}, and/or P_{PowerClass, SL}.

In certain embodiments, the one or more parameters comprise one or more of the following: P_{EMAX}, P_{MAX, SL}, and/or P_{PowerClass, SL}. In certain embodiments, the one or more parameters comprise a compensation parameter for adjusting a parameter for evaluating cell selection criterion that the wireless device is configured to use to determine whether sidelink operation of the wireless device is considered to be inside or outside coverage of a cell. In certain embodiments, the one or more parameters comprise one or more of: a first maximum allowed sidelink transmission power associated with Mode 2 and an out-of-coverage condition; a second maximum allowed sidelink transmission power associated with the Mode 2 and an in-coverage condition; and/or a third maximum allowed sidelink transmission power associated with Mode 1 and the in-coverage condition.

In certain embodiments, at least one of the one or more parameters indicates that the wireless device is to determine whether the sidelink operation of the wireless device is considered to be inside or outside the coverage of the cell with respect to at least one of the following carriers: a carrier that is the same as a carrier that the wireless device uses for sidelink operation; a carrier that is adjacent to the carrier that the wireless device uses for sidelink operation; a carrier that is in a same band as the carrier that the wireless device uses for sidelink operation; and/or a carrier that is within a pre-determined frequency of the carrier that the wireless device uses for sidelink operation.

In certain embodiments, the one or more parameters indicate that the wireless device is to stop transmission of sidelink signals when the wireless device is considered to be inside coverage of the cell. In certain embodiments, the one or more parameters indicate that the wireless device is to stop reception of sidelink signals when the wireless device is considered to be inside coverage of the cell. In certain embodiments, the one or more parameters indicate that the wireless device is to reduce a maximum transmit power used for transmission of sidelink signals when the wireless device is considered to be inside coverage of the cell. In certain embodiments, the one or more parameters indicate that the wireless device is to periodically determine whether the sidelink operation of the wireless device is considered to be inside or outside the coverage of the cell.

The method proceeds to step 2104 with transmitting to the wireless device the one or more parameters determined in step 2102. In certain embodiments, at least one of the one or more parameters may be transmitted in System Information. In certain embodiments, at least one of the one or more parameters may be transmitted in dedicated RRC signaling. In certain embodiments, at least one of the one or more parameters may be transmitted in a MAC CE. In certain embodiments, at least one of the one or more parameters may be transmitted in L1 signaling (such as signaling on a PDCCH or PDSCH). Certain embodiments further provide the wireless device with information indicating for how long at least one of the one or more parameters remains valid after the wireless device exits network coverage.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure.

Other changes, substitutions, and alterations are possible without departing from the scope of this disclosure, as defined by the following claims.

1.-58. (canceled)

59. A method performed by a wireless device, the method comprising:
determining a coverage detection criterion based on one or more obtained parameters;
determining, based on the determined coverage detection criterion, whether sidelink operation of the wireless device is considered to be inside or outside the coverage of the cell; and
adjusting the sidelink operation in response that the sidelink operation of the wireless device is considered to be outside the coverage of the cell.

60. The method of claim 59, wherein the one or more obtained parameters for determining coverage detection criteria comprises at least one of: maximum transmit power of the wireless device in a cell (PEMAX), maximum transmit power of the wireless device in the sidelink (PMAX, SL), and a power class of the wireless device in sidelink (PPowerClass, SL).

61. The method of claim 60, further comprising: obtaining at least one of the one or more obtained parameters from a network node.

62. The method of claim 59 wherein determining the coverage detection criterion comprises: determining a power compensation, Pcompensation, value based on the one or more parameters.

63. The method of claim 62, wherein determining whether sidelink operation of the wireless device is considered to be inside or outside the coverage of the cell comprises: determining based on a signal strength threshold which is determined according to the value of Pcompesation.

64. The method of claim 63, wherein the signal strength threshold is further determined according to one or more of the following parameters:
reference signal received power (RSRP), reference signal received quality (RSRQ), received signal strength indicator (RSSI), signal-to-interference ratio (SIR), signal-to-interference plus noise ratio (SINR).

65. The method of claim 59, wherein adjusting the sidelink operation comprises: stopping transmission and/or reception of sidelink signals, and/or switching a mode used by the wireless device.

66. The method of claim 59, wherein adjusting the sidelink operation comprises reducing a maximum transmit power used for transmission of sidelink signals.

67. The method of claim 59, further comprising, in response to determining that the wireless device is outside coverage of any cell, performing one or more of the following:
enabling transmission of sidelink signals;
enabling reception of sidelink signals; and/or
increasing a maximum transmit power used for transmission of the sidelink signals.

68. The method of claim 59, wherein determining whether the sidelink operation of the wireless device is considered to be inside or outside the coverage of the cell is performed with respect to one or more carriers that are:
same as a carrier that the wireless device uses for sidelink operation;
adjacent to the carrier that the wireless device uses for sidelink operation;
in a same band as the carrier that the wireless device uses for sidelink operation; and/or
within a pre-determined frequency of the carrier that the wireless device uses for sidelink operation.

69. A method performed by a network node, the method comprising:
transmitting, to a wireless device, one or more parameters that the wireless device uses to determine a coverage detection criterion, the coverage detection criterion indicating whether sidelink operation of the wireless device is considered to be inside or outside coverage of a cell.

70. The method of claim 69, wherein the one or more parameters are transmitted as configuration to the wireless device and comprise one or more of the following:
a maximum transmit power of the wireless device in a cell (PEMAX), a maximum transmit power of the wireless device in the sidelink (PMAX, SL), and a power class of the wireless device in sidelink (PPowerClass, SL).

71. A wireless device, the wireless device comprising:
power supply circuitry configured to supply power to the wireless device; and
processing circuitry configured to:
determine a coverage detection criterion based on one or more obtained parameters;
determine, based on the determined coverage detection criterion, whether sidelink operation of the wireless device is considered to be inside or outside the coverage of the cell; and
adjust the sidelink operation in response that the sidelink operation of the wireless device is considered to be outside the coverage of the cell.

72. The wireless device of claim 71, wherein the one or more obtained parameters for determining coverage detection criteria comprises at least one of: maximum transmit power of the wireless device in a cell (PEMAX), maximum transmit power of the wireless device in the sidelink (PMAX, SL), and a power class of the wireless device in sidelink (PPowerClass, SL).

73. The wireless device of claim 72, wherein the processing circuitry is further configured to obtain at least one of the one or more obtained parameters from a network node.

74. The wireless device of claim 71, wherein processing circuitry configured to determine the coverage detection criterion comprises processing circuitry configured to determine a power compensation, Pcompensation, value based on the one or more parameters.

75. The wireless device of claim 74, wherein processing circuitry configured to determine whether sidelink operation of the wireless device is considered to be inside or outside the coverage of the cell comprises processing circuitry configured to determine based on a signal strength threshold which is determined according to the value of Pcompesation.

76. The wireless device of claim 75, wherein the signal strength threshold is further determined according to one or more of the following parameters:
reference signal received power (RSRP), reference signal received quality (RSRQ), received signal strength indicator (RSSI), signal-to-interference ratio (SIR), signal-to-interference plus noise ratio (SINR).

77. The wireless device of claim 71, wherein processing circuitry configured to adjust the sidelink operation comprises processing circuitry configured to stop transmission and/or reception of sidelink signals, and/or switch a mode used by the wireless device.

78. A network node, the network node comprising:
power supply circuitry configured to supply power to the network node; and
processing circuitry configured to perform the method according to claim 69.
